(19) United States
(12) Patent Application Publication
(10) Pub. No.: US 2016/0136524 A1
(43) Pub. Date: May 19, 2016

(54) Story Development Tool

(71) Applicant: Amplify Education, Inc., New York, NY (US)

(72) Inventors: Justin Leites, New York, NY (US); Laura Vila Rawson, New York, NY (US); Timothy A. Sweeney, Pittsburgh, PA (US); Jesse N. Schell, Carnegie, PA (US)

(21) Appl. No.: 14/858,186

(22) Filed: Sep. 18, 2015

Related U.S. Application Data
(60) Provisional application No. 62/080,872, filed on Nov. 17, 2014.

(51) Int. Cl. A63F 13/77; A63F 13/825

(52) U.S. Cl. CPC A63F 13/77; A63F 13/825

(57) ABSTRACT

Methods, systems, and apparatus, including computer programs encoded on a computer storage medium, for a story development tool. In one aspect, a method includes presenting, for selection by a user, one or more settings and one or more characters. The method further includes receiving a selection by the user of a setting and a character for three or more acts of a story, wherein one of the three or more acts is a beginning act and another one of the three or more acts is an ending act. The method further includes receiving a data identifying a particular action. The method further includes receiving data indicating a transition between two of the three or more acts, wherein the transition is triggered by the particular action. The method further includes determining whether there exists a path from the beginning act to the ending act based on the data indicating the transition.

### CROSS-REFERENCE TO RELATED APPLICATION

This application claims the benefit of U.S. Provisional Application No. 62/080,872, filed Nov. 17, 2015, entitled “STORY DEVELOPMENT TOOL”, which is incorporated by reference herein.

### TECHNICAL FIELD

This specification generally relates to game and story creation.

### BACKGROUND

A typical story includes a plot, characters, and setting. To create a story, a writer may create an outline of the plot and consider how to develop the characters within the plot and describe the setting. With the outline created, the write may begin writing the story.

### SUMMARY

According to an innovative aspect of the subject matter described in this specification may be implemented in methods that include the actions of presenting an outline for a story, the outline including empty acts; presenting, for selection by a user, one or more characters and one or more settings; receiving a selection by the user of one of the empty acts; receiving, for the selected empty act, a selection by the user of one of the characters and one of the settings; receiving a request from the user for a plot suggestion for the selected empty acts; determining a plot suggestion based on the selected character and the selected setting; presenting the determined plot suggestion; receiving a selection by the user of the plot suggestion; receiving a request from the user for a character suggestion, a setting suggestion, or an additional plot suggestion for one of the empty acts in the outline other than the selected empty act; in response to receiving the request from the user for a character suggestion, a setting suggestion, or an additional plot suggestion, determining a character suggestion, a setting suggestion, or an additional plot suggestion based on the determined plot suggestion, the selected character, and the selected settings; and presenting the determined character suggestion, the determined setting suggestion, or the determined additional plot suggestion.

These and other embodiments can each optionally include one or more of the following features. The empty acts include a beginning act, an ending act, and one or more middle acts. The one or more characters include previously selected characters and additional characters that are randomly selected, and the one or more settings include previously selected settings and additional settings that are randomly selected. The action of determining a plot suggestion based on the selected character and the selected setting includes determining the plot suggestion further based on previous stories created by the user or comments provided by other users on the previous stories created by the user. The character suggestion includes a dialogue suggestion for the character or response suggestion to respond to dialogue from the character. The additional plot suggestion includes a transition suggestion to a created act that is in the outline, an uncreated act that is not included in the outline, or a scene in a current act. The setting suggestion includes a prop suggestion.

In general, another innovative aspect of the subject matter described in this specification may be implemented in methods that include the actions of presenting, for selection by a user, one or more settings and one or more characters; receiving a selection by the user of a setting and a character for three or more acts of a story, where one of the three or more acts is a beginning act and another one of the three or more acts is an ending act; receiving a data identifying a particular action; receiving data indicating a transition between two of the three or more acts, where the transition is triggered by the particular action; and determining whether there exists a path from the beginning act to the ending act based on the data indicating the transition.

These and other embodiments can each optionally include one or more of the following features. The particular action includes dialogue, interaction with a prop, or interaction with a portion of the setting. The actions further include receiving additional data indicating the transition is between one of the two of the three or more acts and a different act; and determining whether there exists a path from the beginning act to the ending act based on the additional data indicating the transition. The action of determining whether there exists a path from the beginning act to the ending act based on the data indicating the transition includes determining that there exists the path from the beginning act to the ending act based on the data indicating the transition; and presenting an indication that the path from the beginning act to the ending act exists. The action of determining whether there exists a path from the beginning act to the ending act based on the data indicating the transition includes determining that there does not exist the path from the beginning act to the ending act based on the data indicating the transition; presenting an indication of different paths between the three or more acts; and receiving data to revise the transition. The actions further include presenting data indicating a correction to the transition so that the path from the beginning act to the ending act exists.

Particular implementations of the subject matter described in this specification can be implemented so as to realize one or more of the following advantages. For example, a user may develop techniques to develop logical and coherent stories.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for developing a story.

FIGS. 2-18 illustrate example user interfaces for the story development tool.

FIGS. 19-20 illustrate example user interfaces for interacting with the three dimensional world of a story.

FIGS. 21-32 illustrate an example schematics for the story development tool.

FIGS. 33-34 illustrate example processes for developing a story.

Like reference numbers and designations in the various drawings indicate like elements.

### DETAILED DESCRIPTION

In brief, this disclosure describes a story development tool implemented on a computing device, such as a tablet computing device. The story development tool allows a user to create an interactive story and an accompanying three dimensional world. The user can share the interactive story with a player and the player can play through the interactive story by moving an avatar through the three dimensional world and interacting with the three dimensional world through the avatar. The story development tool assists the user, typically a student, in creating the story by providing a framework for a story. The story development tool provides an interface that allows the student to outline the different acts of the story and create settings in the three dimensional world that correspond to each act. The student can edit the settings in the three dimensional world by adding different rooms and changing the texture and colors of the room with different colors and patterns provided by the story development tool. The settings provide the world that a player can interact with when playing through the story.

The student may also add characters to occupy the settings and add dialogue to each character. The student may associate with each character a series of dialogue lines and responses that a player can select when interacting with the character. The student may also add props to the setting that the player may interact with. To move a player between acts, a student may add a transition. The transition may be caused by actions taken in the three dimensional world by the player through the avatar. For example, a transition may occur as a result of a particular dialogue line that a player selects in response to a dialogue line spoken by a character or by a user entering a particular area of the setting. Transitions allow the player to select a path through the story so that each player experiences the story in a different way, while each player attempts to reach the end of the story.

At each stage of adding either descriptions to the acts, characters, props, dialogue, or settings, the story development tool may provide a suggestion to the student. The suggestion may be a random suggestion or may be based on the rest of the descriptions, acts, characters, props, or settings that are already part of the story or are part of a story previously created by the student.

While a student is creating the story, the story development tool may check to ensure that a player can interact with the story by beginning from the first act and ending at the last act. Sometimes a student may create a transition that takes the player to a different act, but because the player has already interacted with the different act, the player may not be able to transition to an act that allows the play to reach the last act. In this instance, the story development tool notifies the student of the error and allows the student to correct the error. In some instances, the story development tool may provide a suggestion to fix the error.

Once the student has created the story and created an interactive three dimensional world for other students to experience, the student may publish the story by uploading it to a server. Students using the other computing devices that are connected to the server may download the story and interact with the three dimensional world. Those other players may leave comments for the student who created the story or other students as those students play through the three dimensional world of the story.

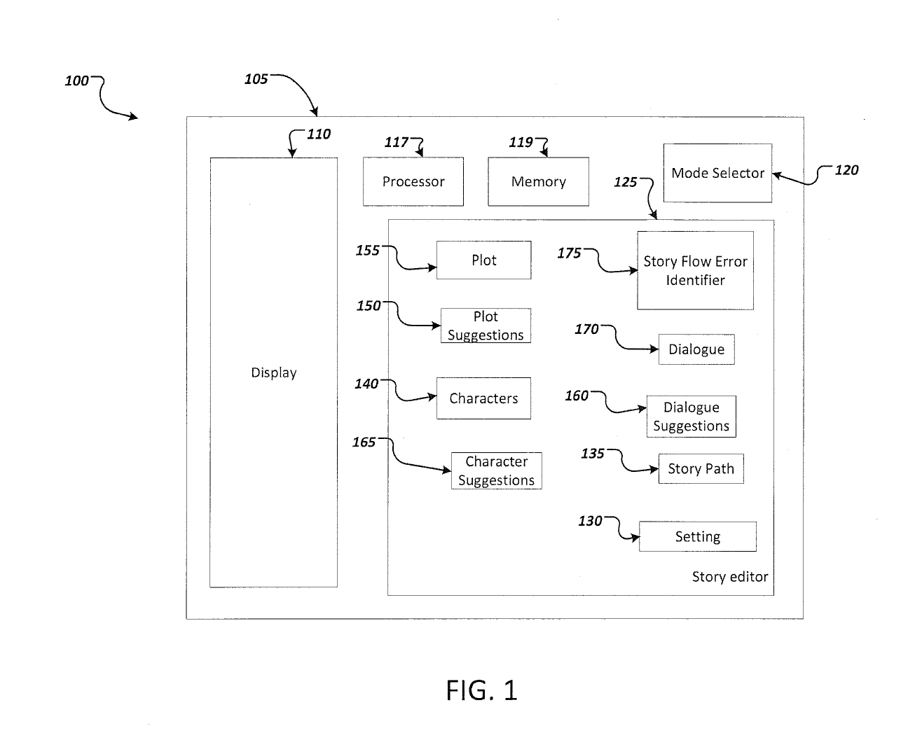

FIG. 1 illustrates an example of a system 100 for developing a story. The system 100 includes a client device 105 for a user to interact with the story development tool. The client device 105 may be any type of computing device such as a mobile phone, a tablet, a laptop, or a desktop computer. The client device 105 includes a display 105 for displaying the story development tool. The client device 105 includes a processor 117 and memory 119. The memory 119 is a computer readable medium that stores software that can be executed by the processor 117. For example, the memory 119 stores software for implementing the story development tool. In some implementations, the processor 117 includes additional processing devices. In some implementations, the processor 117 may access a computer readable medium through a network, for example, when the computer readable medium is in a server.

The client device 105 includes a mode selector 120. The mode selector 120 provides different options to the user such as creating a story or playing a story created by another user. When the user selects the story creation mode, the display 110 displays a story editor 125. To begin creating the story, the user creates a plot 155. The plot may be a short description for the story. In instances where the user is having difficulty coming up with a plot, the story editor 125 may select a plot suggestion 150. The story editor 125 may select a plot suggestion at random or select a plot suggestion based on a variety of other factors described later in this disclosure. The user may choose to split up the story into different acts and provide a description for each of the acts. The story editor 125 may provide act description suggestions similarly to how the story editor provides plot suggestions.

The user may design a setting 130 for the story. The story editor 125 may provide several types of rooms that a user may select from to build a setting 130 for the story. For example, the user may select a square room and attach the square room to circular room. The user may then select colors and textures from a palette provided by the story editor 125 and add the color or texture to the setting. The user may add one or more characters 140 to the setting. The characters may be selected from a group of characters provided by the story editor 125. In some implementations, the user may request that the story editor 125 provide suggestions for what characters to include in the story. These characters may include characters from books that the user may be assigned to read in school. For example, the user may be a student who is assigned to read To Kill a Mockingbird and the characters may include Atticus Finch and Boo Radley. The user may add dialogue 170 to the characters. In some implementations, the user may request that the story editor 125 provide dialogue suggestions 160 for the characters.

In creating the dialogue 170 for each character, the user may create a dialogue tree. The dialogue tree can begin with a line that one of the characters will say when a user interacting with the story approaches the character. The creating user may include different responses that the interacting user (that is, the player) can select during the story. In some implementations, the creating user may include that certain dialogue answers that transition the interacting user to another part of the story such as a subsequent act. In creating one or more transitions, the user creates a story path 135. The story path may be a path with multiple branches that begins at the beginning of the story and ends at the ending of the story.

In some instances, the user may unintentionally create a story path that does not connect the beginning to the end. The story editor 125 may include a story flow error identifier 175 that traverses the story path 135 to ensure that the beginning connects to the end. The story flow identifier 175 may traverse and check the story path 135 after each time the user edits the dialogue and adds or removes a transition. For example, a user may adjust the transition for one response that an interacting user can select when talking to a character. The user may change the setting that the story transitions from the woods to the castle. If transitioning the story to the castle results in the path from the beginning to the end being broken, then the story flow identifier 175 will alert the user creating the story to the error. In some implementations, the story flow error identifier 175 may suggest how to correct the error in the story path 135.

Once the user finishes creating the story and the interactive three dimensional world, the user may publish the story. To publish the story, the user may upload the story to a server or select the story to be shared with other users. The user may select particular users with whom to share the story. The user may download the story to a computing device and play the story. The playing users may leave comments for other players and for the creating user.

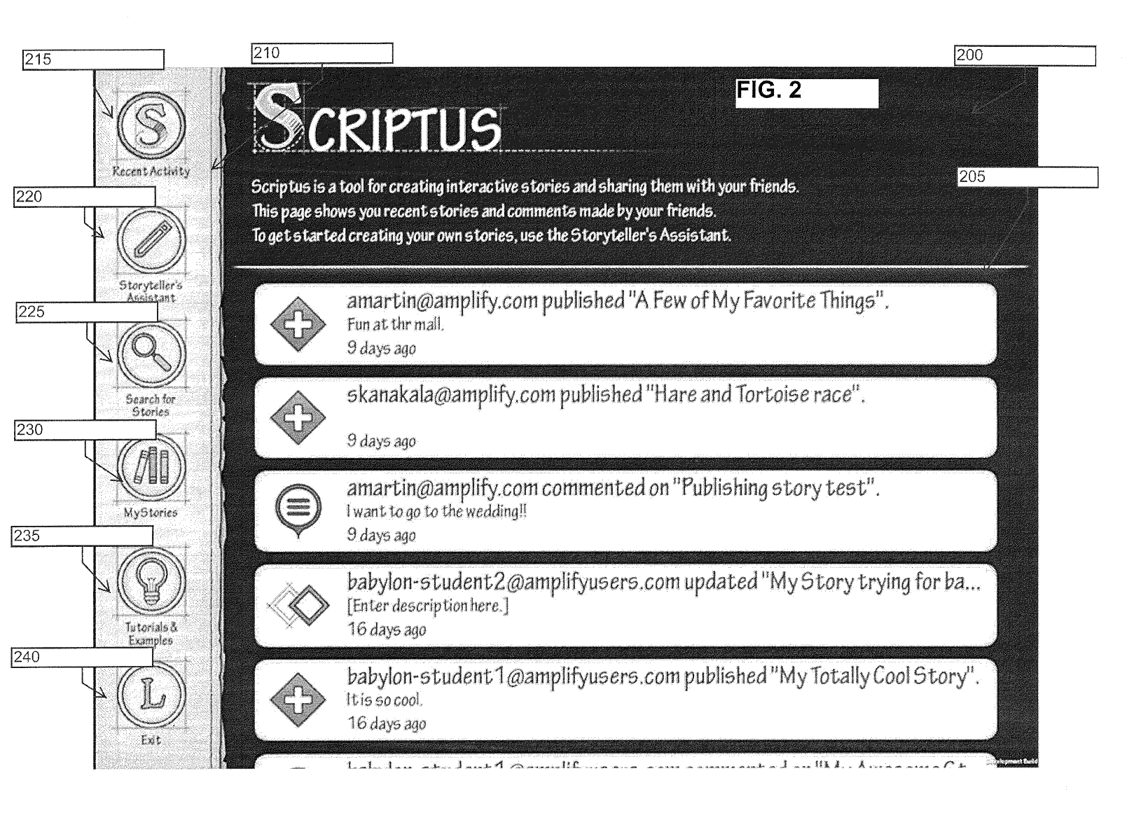

FIG. 2 illustrates an example user interface 200 for launching the story development tool. The user interface 200 includes a feed 205 that includes the recent activity of other users. The activity can include links to stories that other users have developed, comments that other users have posted, stories that other users have updated, or stories that other users have recently played. For example, the feed 205 may include an update indicating that user “amartin” has published a new story entitled “A Few of My Favorite Things.” The feed 205 may also include an update indicating that a user “Babylon-student2” updated a previously published story “My Story trying for bananas.” Each update may include the time that has elapsed since the update has occurred. In instances where the update indicates that a user has left a comment, the comment or a snippet of the comment may be included in the feed 205. Selecting one of the links may cause the device to display the story that is associated with the link. In instances where the link is associated with a comment, selecting the link may cause the device to display the comment or the particular location in the story where the user left the comment. In instances where the link is associated with an update, selecting the link may cause the device to display the portion of the story that the user updated. The users whose updates are included in a particular user's feed 205 may be users that the particular user has previously identified. For example, the users in the feed 205 may be in the particular user's social network. In some implementations, a user may have to opt in to have the user's updates included in another user's feed 205.

The example user interface 200 may also include a menu 210 that includes selectable icons. In some implementations, the device may display the menu 210 while displaying any user interface of the story development tool. A user may select one of the selectable icons to navigate to a different portion of the story development tool. The user may select icon 215 to display the feed 205 that includes the recent activity of other users. The user may select icon 220 to launch the Storyteller's Assistant that guides a user through the development of a story. The user may select icon 225 to search for other stories that the user has created as well as other stories created by other users. The user may select icon 230 to display the stories created by the user. Selecting the icon 230 may also cause the device to display stories that the user has flagged, such as stories created by other users that the user enjoyed playing. The user may select icon 235 to display a tutorial or example for using the story development tool. The user may select icon 240 to quit the story development tool.

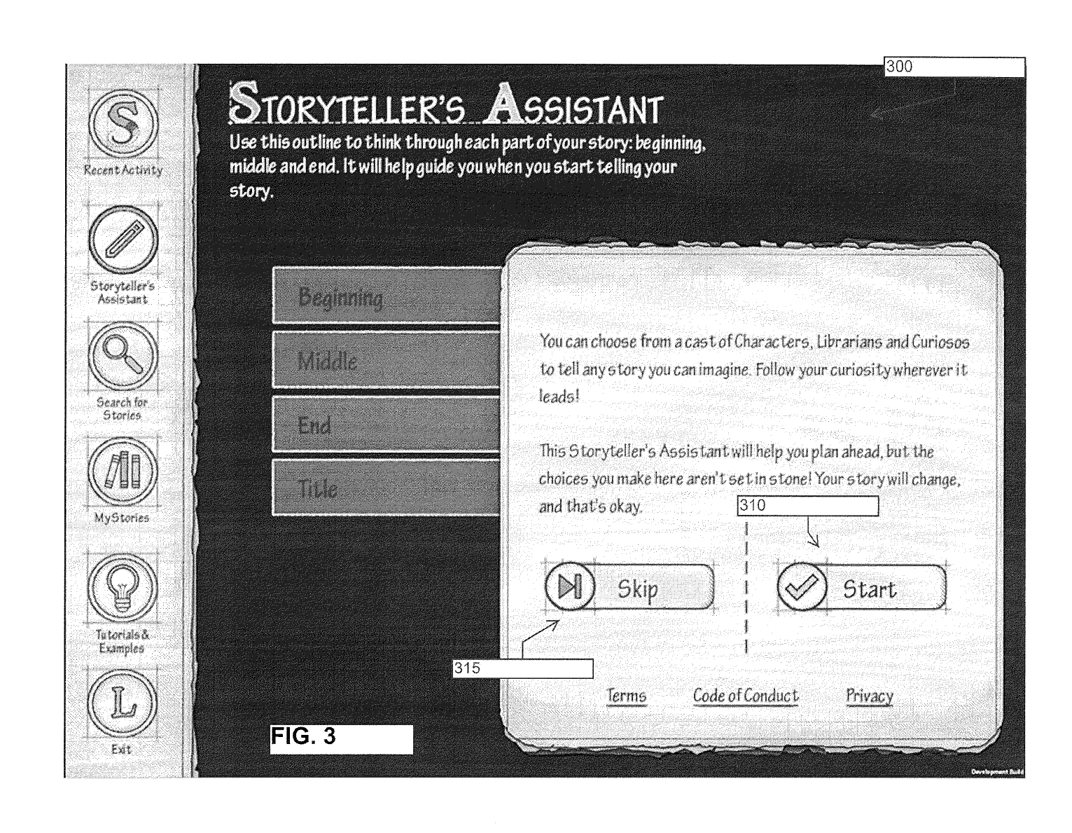

FIG. 3 illustrates an example user interface 300 for launching the story development tool. The device may display the user interface 300 when the user selects icon 220. In some implementations, the device may require the user to use the story development tool to develop the user's first story. For subsequent stories, the device may not require the user to use the story development tool. For example, the user interface 300 includes icon 310 to begin the story development tool. To skip the story development tool, the user may select icon 315.

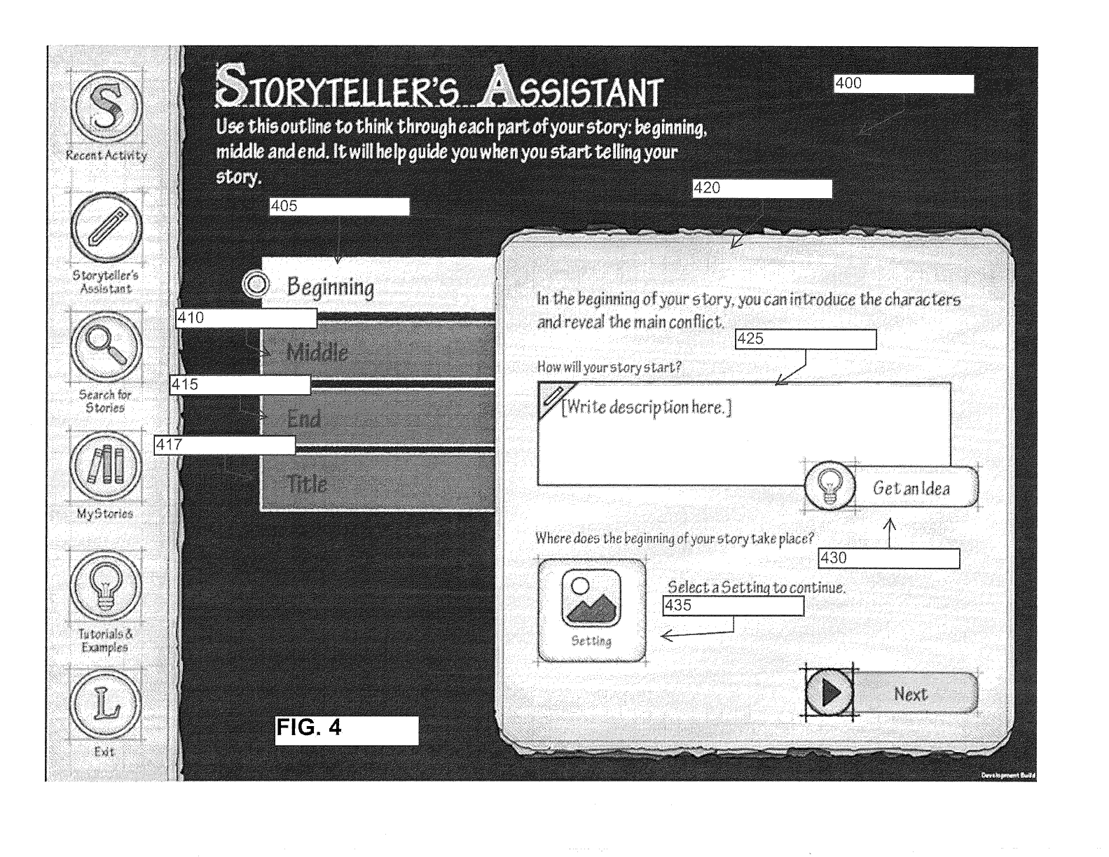

FIG. 4 illustrates an example user interface 400 for the story development tool. The device may display the user interface 400 when the user selects icon 310. As shown in user interface 400 the story development tool assists the user in developing a story that contains three acts, a beginning, a middle, and an end. The user may select the beginning icon 405, the middle icon 410, or the ending icon 415 to display options to enter information associated with the selected act. For example, selecting icon 405 causes the display to dialog box 420. Dialog box 420 includes a text box 425 that provides space for the user to type a description for the plot of the beginning of the story. The user may select button 430 to cause the device to display some ideas for the beginning of the story. Selecting button 435 causes the device to display a user interface to allow the user to edit the setting associated with the beginning act. Selecting buttons 410 and 415 causes the device to display dialog boxes similar to dialog box 420 that allow the user to edit the plot and setting of the middle act or the ending act. Selecting button 417 causes the device to display a user interface that allows the user to edit the title of the story.

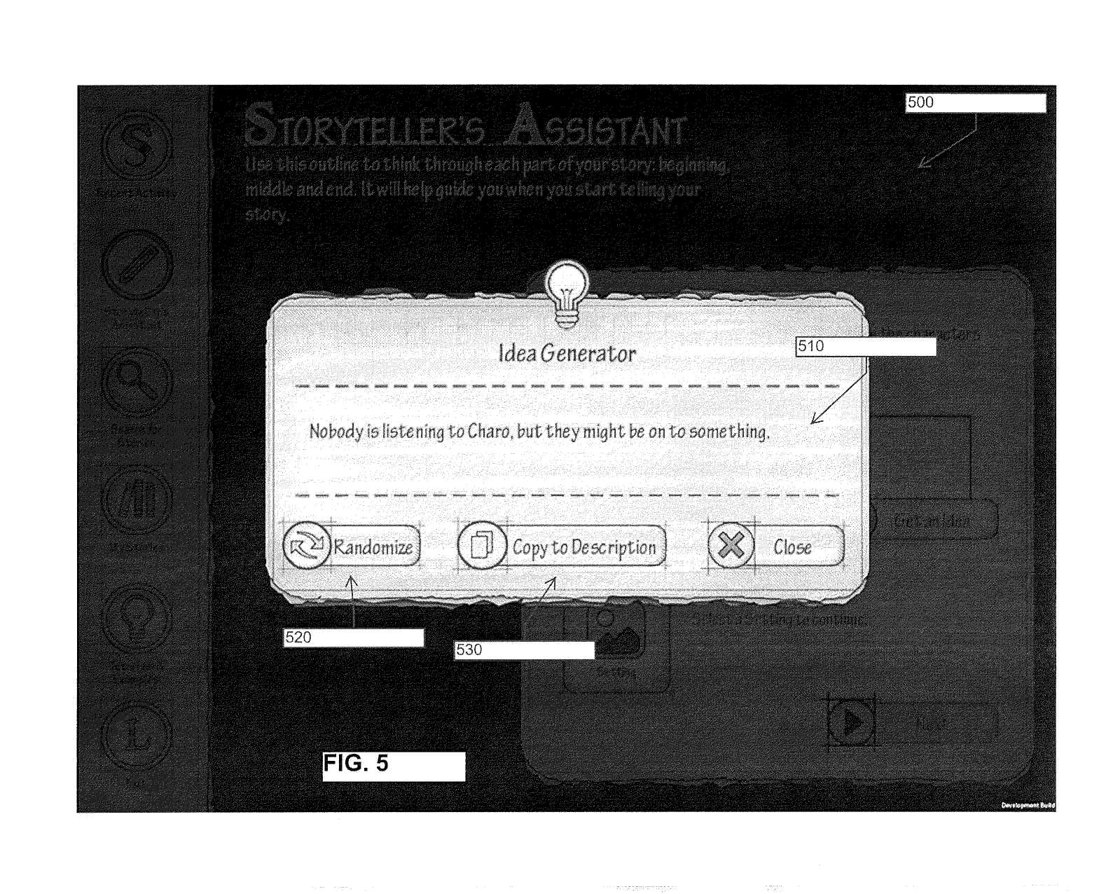

FIG. 5 illustrates an example user interface 500 for the story development tool. The device may display the user interface 500 when the user selects button 430. The user interface 500 includes a plot idea 510 for the act that the user is currently editing. The plot idea may be a random idea selected from a group of ideas. The group of ideas may be ideas submitted by other users or submitted by creators of the story development tool. The plot ideas may also be related to previous stories that the user developed or to the other acts of the story that the user is developing. Selecting button 520 refreshes the plot idea 510 with a random plot idea. Selecting button 530 copies the plot idea 510 to text box 425.

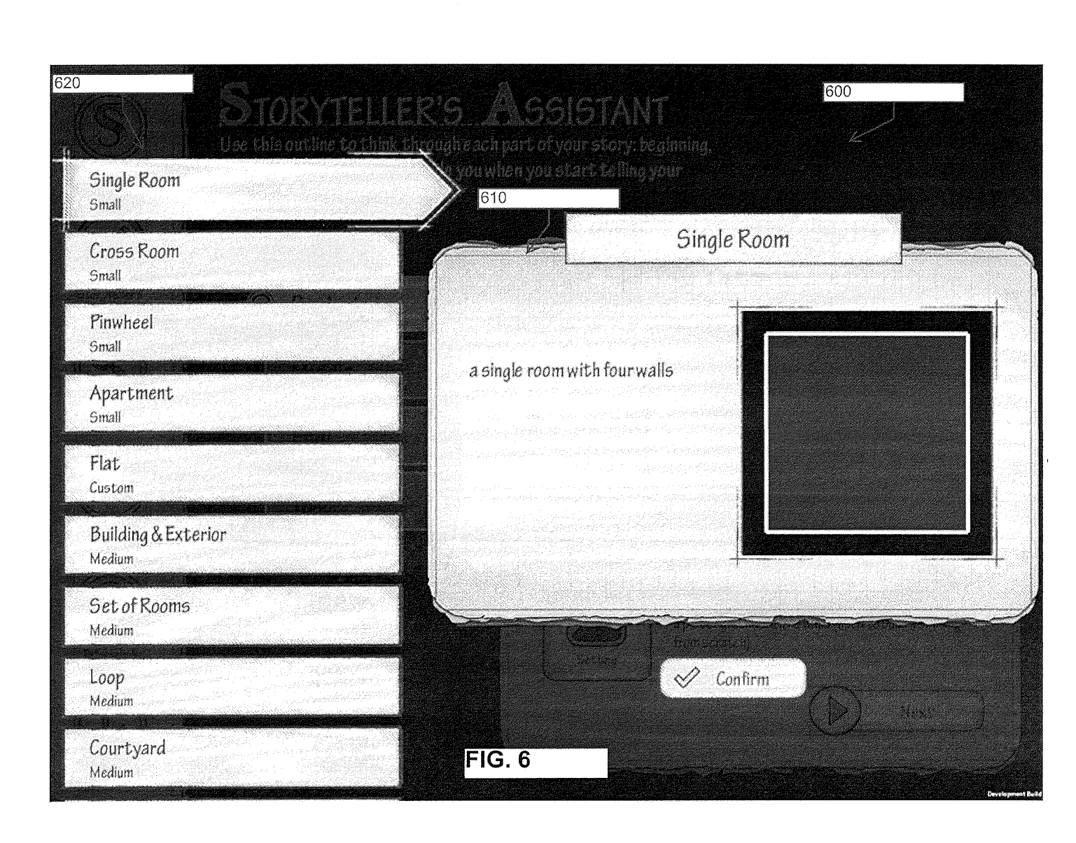

FIG. 6 illustrates an example user interface 600 for the story development tool. The device may display the user interface 600 when the user selects button 435. The user interface 600 includes a setting display 610 that displays the setting selected from menu 620. In some implementations, the setting options displayed in the menu 620 may include a predetermined group of setting options that are included by the creators of the story development tool. In some implementations, the settings options displayed in the menu 620 may include settings that the user included in previous stories. For example, if the user used the courtyard setting in a previous story, then the menu 620 may include the courtyard option. In some implementations, the device may select the setting options that are most closely related to the plot idea 510, if the user has inputted a plot idea.

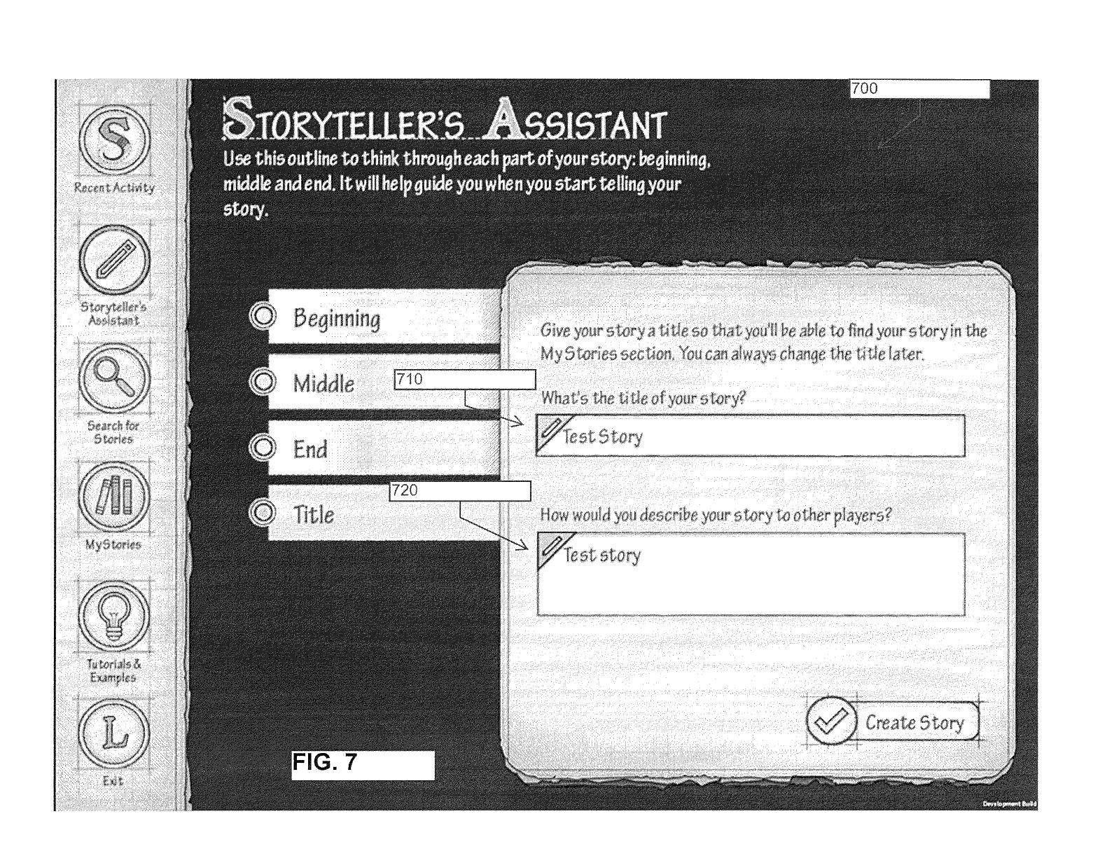

FIG. 7 illustrates an example user interface 700 for the story development tool. The device may display the user interface 700 when the user selects button 417. The user interface 700 includes text box 710 where the user can input a title for the story and text box 720 where the user can include a description for the story. In some implementations, the user interface 700 includes a title suggestion button. When the user selects the title suggestion button, the device may display title suggestions for the text box 710. The title suggestions may be based on the plots that the user input for the acts of the story. In some implementations, the user interface 700 includes a description suggestion button. When the user selects the description suggestion button, the device may display description suggestions for the text box 720. The description suggestions may be based on the title or the acts of the story or both. The device will use the title and description as identifiers to identify the story to other users.

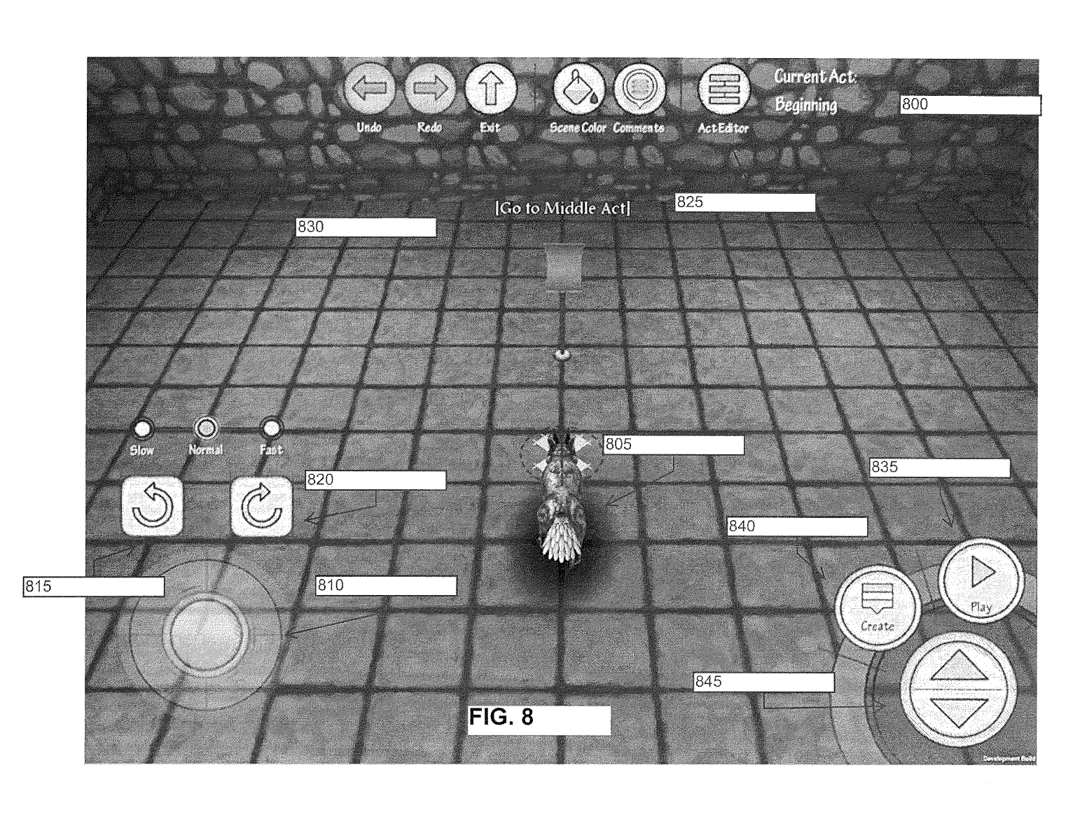

FIG. 8 illustrates an example user interface 800 for the story development tool. The user interface 800 is a three dimensional, interactive representation of the user's story. The interactive representation can include characters and props that other users can interact with when playing the story. User interface 800 provides an avatar 805 that the user can control with control 810. The user may control the perspective of the user interface 800 by selecting rotation buttons 815 or 820. Selecting rotation button 815 rotates the perspective of the user interface 800 counter clockwise, and selecting rotation button 820 rotates the perspective of the user interface 800 clockwise. The user controls the avatar 805 around the user interface 800 and inserts props and characters to create three dimensional world for the story. The user interface 800 includes an act editor button 825 that the user can select to launch the act editor. To control the act that is currently displayed, the user may select button 830. For example, if the user interface 800 displays the beginning act, then the user can select button 830 to display the middle act.

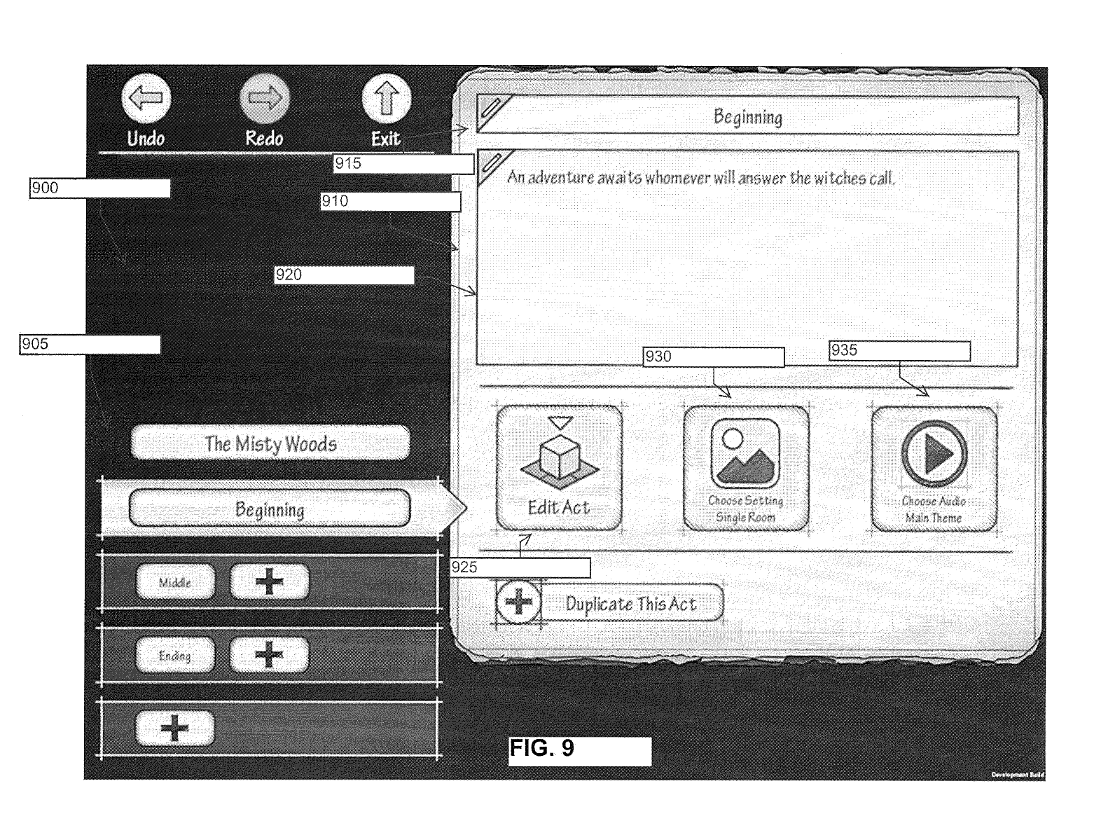

FIG. 9 illustrates an example user interface 900 for the story development tool. User interface 900 provides an editor for the user to edit a particular act. The device displays user interface 900 in response to the user selecting the act editor button 825. User interface 900 includes an act structure interface 905 that displays the different acts of the story and any scenes that are a part of each act. User interface includes an act editor 910 that includes options that a user can select to edit those portions of the act. The user may edit the text box 915 to rename the act, or edit the description of the act in text box 920. For example, the user may include the description of “An adventure awaits whomever will answer the witches call” in text box 920. The act editor 910 includes an edit act button 925 that a user can select to edit the interactive setting of the act, a setting selection button 930 that a user can select to edit the spatial constraints of the act, and an audio selection button 935 that a user can select to select the audio for the act. Selecting the setting selection button 930 causes the device to display the user interface 600.

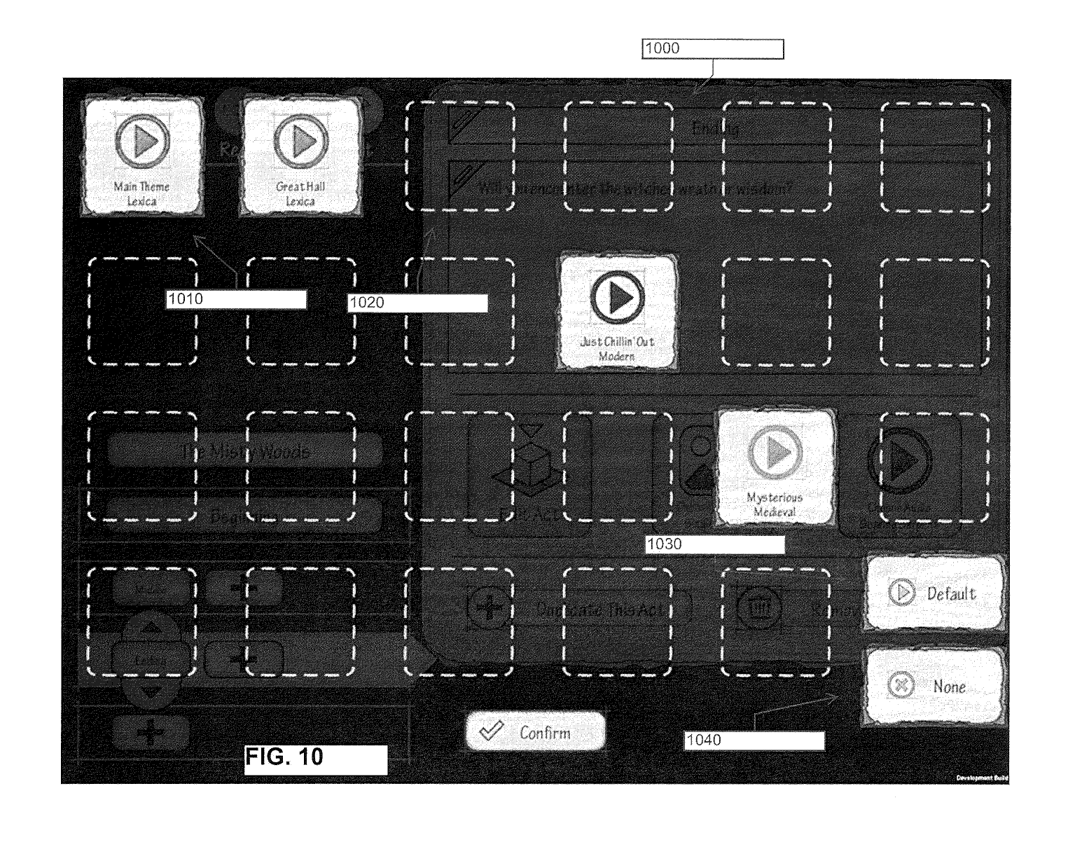

FIG. 10 illustrates an example user interface 1000 for the story development tool. User interface 1000 provides a music selection interface that may be shown when the user selects button 935 and allows the user to select different audio that will be played in the corresponding act while another user is interacting with the story. User interface 1000 includes multiple slots that allow the user to place a different audio track to be played in different portions of the story. Slot 1010 illustrates a filled slot, and slot 1020 illustrates an empty slot. In some implementations, the slots may be filled by the user during development of the story. In some implementations, the slots may be filled by a creator of the story development tools so that the slots include a variety of different audio tracks. Some of the audio tracks may be tied to different audio tracks may be tied to different rooms. For example, an audio track may play when a user is in the great hall and a different audio track may play when the user is in the parlor. These locations for the audio tracks may be included in the slots. A user may also select button 1030 to select the default audio for the selected act. The default audio may be selected by the creator of the story development tool or by the user. If the user does not want an audio track to play during the selected act, then the user can select button 1040.

Returning to FIG. 8, user interface 800 includes buttons 835 and 840. When the user selects button 835 the user interface 800 becomes an interface that emulates what another user would experience if the other user was playing through the story. When the user selects button 840, the user interface 800 is in editing mode that allows the user to edit the setting, characters, props, and dialog of the story. Selecting button 845 allows the user to cycle through the different scenes or acts without having to return to the user interface 900 to select a different scene or act.

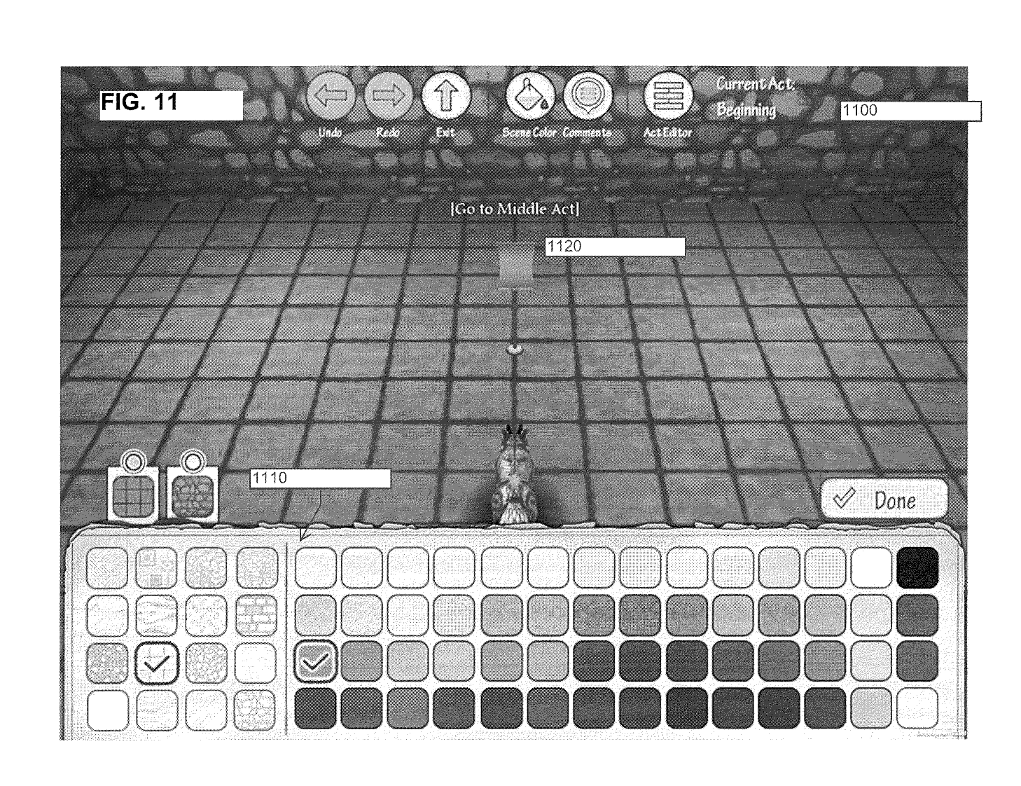

FIG. 11 illustrates an example user interface 1100 for the story development tool. User interface 1100 provides a user interface similar to user interface 800 with the addition of a color and texture palette 1110. The user can select button 1120 to display the palette 1110. The user can select a portion of the user interface 1100 and then select color and texture from the palette 1110 for that portion. For example, the user can select the floor and then select the texture that corresponds to tile and the color brown.

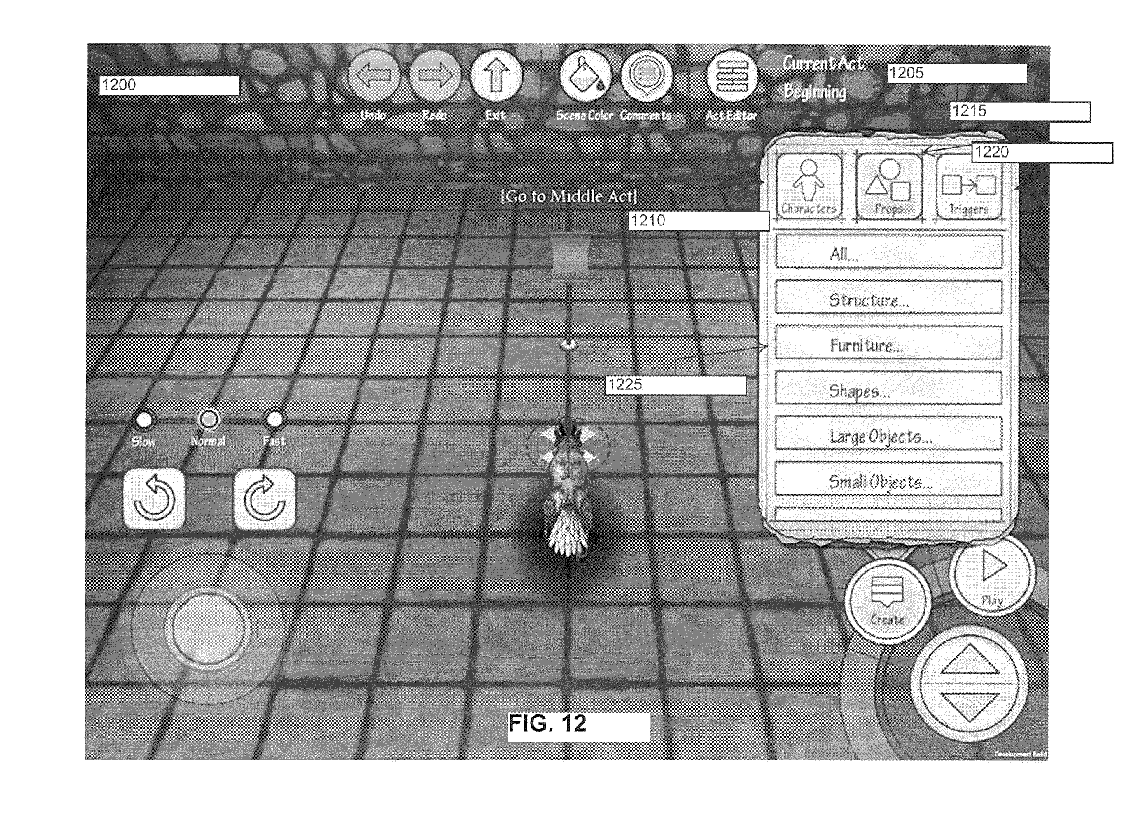

FIG. 12 illustrates an example user interface 1200 for the story development tool. User interface 1200 provides a user interface similar to the user interface 800 with the addition of a create menu 1205. The user interface 1200 displays the create menu 1205 when the user enters create mode by selecting button 845. The create menu 1205 provides different options for the user to add elements to the story. The user can select button 1210 to add a character to the story. Once the user selects button 1210, the menu 1225 displays different types of characters to add to the story. The menu 1225 may provide character suggestions that are based on the description of the act, the title of the story, a setting that the user has selected for the character, any props that may be in the setting, or the user's other choices in creating the story or choices the user made in creating previous stories. The character suggestions may also be randomly provided by the story development tool from a list of predetermined characters or based on comments left by other users who played other stories created by the user. The predetermined characters may be based on books that the user may be assigned to read in school. The user can select button 1215 to add a prop to the story. Selecting button 1215 causes the menu 1225 to display different types of props. For example, the menu 1225 may display groups of props such as structural props, furniture props, shape props, large objects, and small objects. The menu 1225 may provide prop suggestions that are based on the description of the act, the title of the story, a setting that the user has selected for the prop, any characters and their dialogue that the user has selected, or the user's other choices in creating the story. The prop suggestions may also be randomly provided by the story development tool from a list of predetermined props or based on comments left by other users who played other stories created by the user. The predetermined props may be based on books that the user may be assigned to read in school. The user can select button 1220 to add a trigger to the story. Selecting button 1220 causes the menu 1225 to display different types of triggers to transition between acts. Similar to the character and prop suggestions, the menu 3225 may include trigger suggestions that are based on the description of the act, the title of the story, the setting where the transition originates, the setting where the transition concludes, any characters and their dialogue that are associated with the trigger, the user's other choices in creating the story, comments left by other users who played other stories created by the user, or randomly provided by the story development tool from a list of predetermined trigger suggestions. The predetermined trigger suggestions may be critical points from books that the user may be assigned to read in school. A trigger may be an action that when performed by a user playing through the story causes another action to occur. For example, if a user playing through the story enters a particular room, then that may trigger a character in the story to speak a particular line.

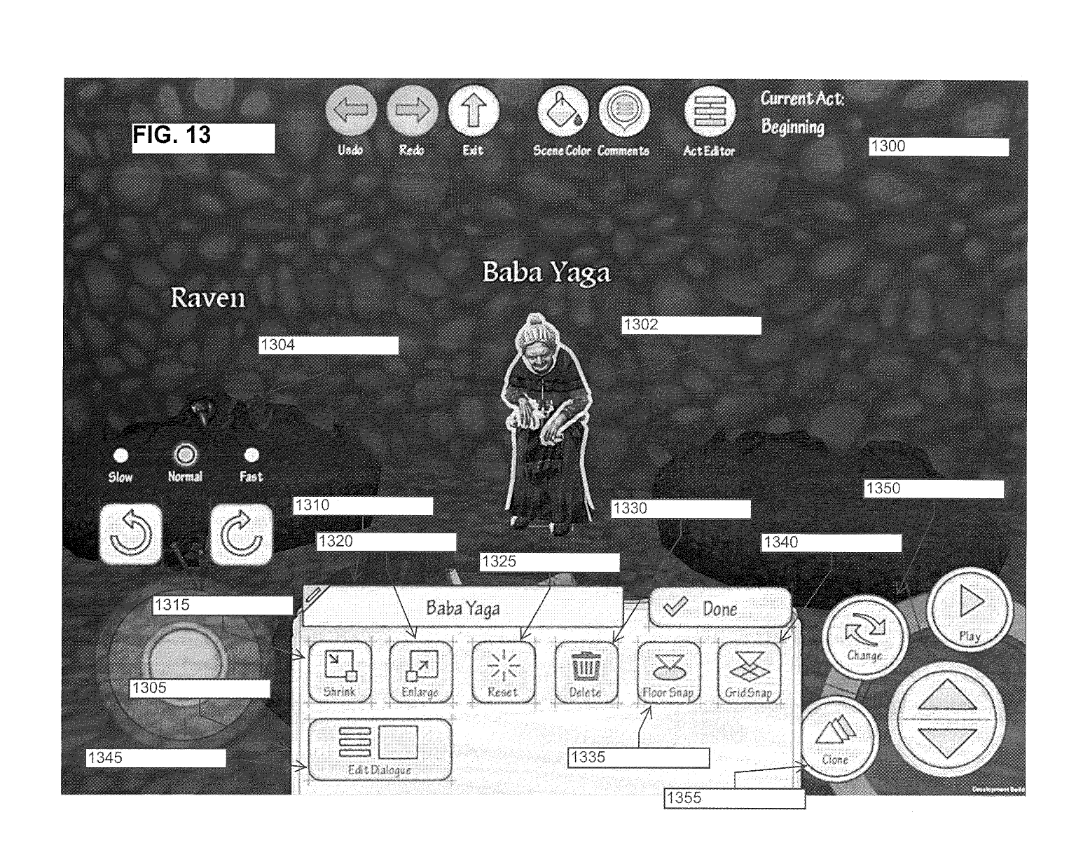

FIG. 13 illustrates an example user interface 1300 for the story development tool. User interface 1300 provides a user interface that allows the user to edit props that were placed using create menu 1205. Once the user selects and places a prop, such as prop 1302 or prop 1304, in the user interface, prop menu 1305 appears. The prop menu allows the user to edit the characteristics of the highlighted prop, such as prop 1302. The prop menu 1305 includes the name of the highlighted prop in text box 1310. The user may edit text box 1310 to assign a new name to the prop. In some implementations, the name for the prop is suggested by the story development tool. The name may be based on the other elements that the user has added to the story or a name that may correspond to the prop, such as “Baba Yaga.” The prop menu 1305 provides several options for the user to edit a prop. The prop menu includes a shrink button 1315 and an enlarge button 1320 that the user can select to change the size of the prop. The user can select reset button 1325 to return the prop to its default configuration such as its default size and name. Selecting the delete button 1330 removes the prop from the user interface. The user can select the floor snap button 1335 to ensure that the prop is placed on the floor of the user interface. Selecting the grid snap button 1340 limits the locations where the user can place the prop to a grid. The user can select dialogue button 1345 to edit the prop's dialogue. The user may select change button 1350 to cycle though different props. As the user selects change button 1350, the highlighted prop may cycle through different props. For example, if prop 1302 is highlighted, then selecting button 1350 causes different props to appear in place of prop 1302. Selecting clone button 1355 causes the story development tool to clone the currently highlighted prop so that the user may edit a copy of the prop.

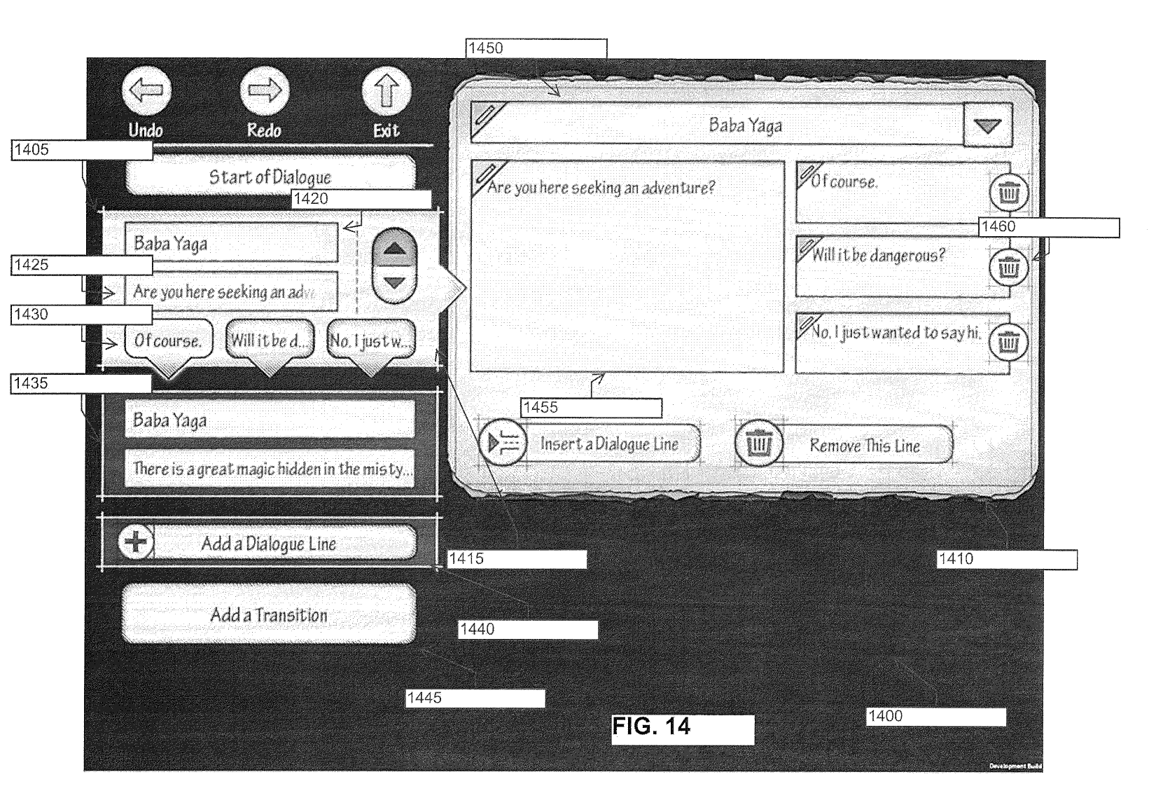

FIG. 14 illustrates an example user interface 1400 for the story development tool. User interface 1400 provides a user interface that allows the user to edit the dialogue of the story. To display user interface 1400, the user selects button 1345 from user interface 1300. User interface 1400 includes a dialogue tree 1405 and a dialogue editor 1410. The dialogue tree 1405 displays the conversation branching structure that a user sees when the user is interacting with the selected prop or character. The dialogue editor 1410 allows the user to edit each piece of dialogue in the dialogue tree 1405.

The dialogue tree 1405 includes a dialogue prompt 1415. The dialogue prompt 1415 includes a character identifier 1420 and character dialogue 1425. When a user is interacting with the story and approaches the character that corresponds to character identifier 1420, then the character speaks the character dialogue 1425. The response options 1430 indicate different options that the user is presented with for response to the character dialogue 1425. Depending on the option selected by the user from the response options 1430, the character may say some different The character's response for a particular response from response option 1430 may be the character response 1435. A user may select a different response option from the response options 1430 to show each of the different character responses for reach different response option. As shown in user interface 1400, a user may interact with the character “Baba Yaga” and Baba Yaga says, “Are you seeking an adventure?” In response, the user may select one of the response options that are “Of course,” “Will it be dangerous,” and “No, I just wanted to say hi.” If the user selects “Of course,” then Baba Yaga will respond with “There is a great magic hidden in the misty . . . . ” To add an additional dialogue line, then the user may select the dialogue adder button 1440. To transition to another act, then the user can select the transition button 1445 that will be discussed in more detail below.

The dialogue editor 1410 allows the user to edit the dialogue tree 1405. The user may edit the character identifier 1420 using text box 1450 or the character dialogue 1425 using text box 1455. The different response options 1430 may be edited with text boxes 1460. In some implementations, the story development tool may suggest dialogue for a character for response options for the user. These dialogue suggestions may be based on one or more of the following factors such as the setting of the act or other acts, dialogue of other characters, comments left by other users who interacted with other stories created by the user, descriptions of the act or other acts, or randomly generated by the story development tool. The dialogue suggestions generated by the story development tool may be based on dialogue lines from books that the user may be assigned to read.

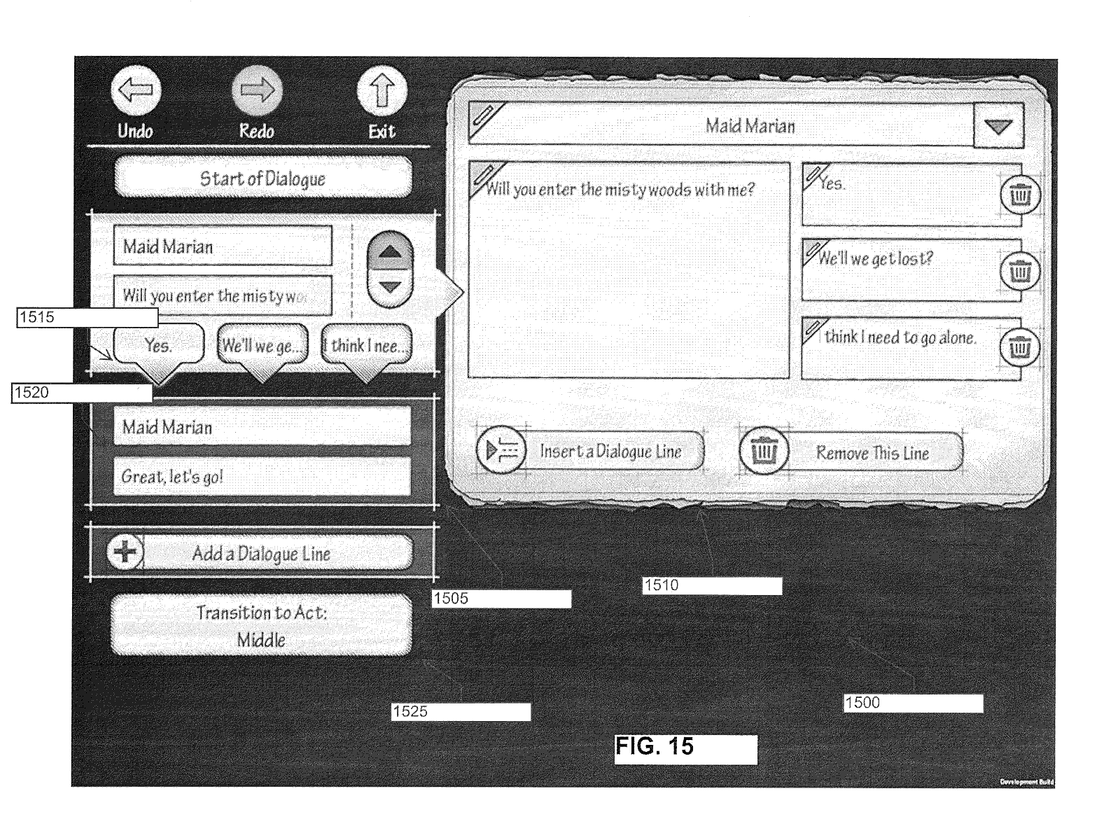

In some instances, particular dialogue may trigger an event or a transition. The transition may cause the act of the story to change. FIG. 15 illustrates an example user interface 1500 for the story development tool. User interface 1500 is similar to user interface 1400 and illustrates a dialogue tree 1505 and dialogue editor 1510 for the character Maid Marian. As shown in the dialogue tree 1505, Maid Marian says, “Will you enter the misty woods with me?” The response options include “Yes,” “Will we get lost,” and “I think I need to go alone.” Dialogue option 1515, “Yes,” is highlighted in the dialogue tree 1505. Therefore, Maid Marian's response when a user selects “Yes” is character dialogue branch 1520, “Great, let's go.” Once Maid Marian says this response, that action triggers the act to move to the middle act as illustrated in transition button 1525. In some implementations, the transition may trigger a scene change, another character to appear or disappear, the user interacting with the story to successfully complete the story or fail at completing the story, or another change in the story.

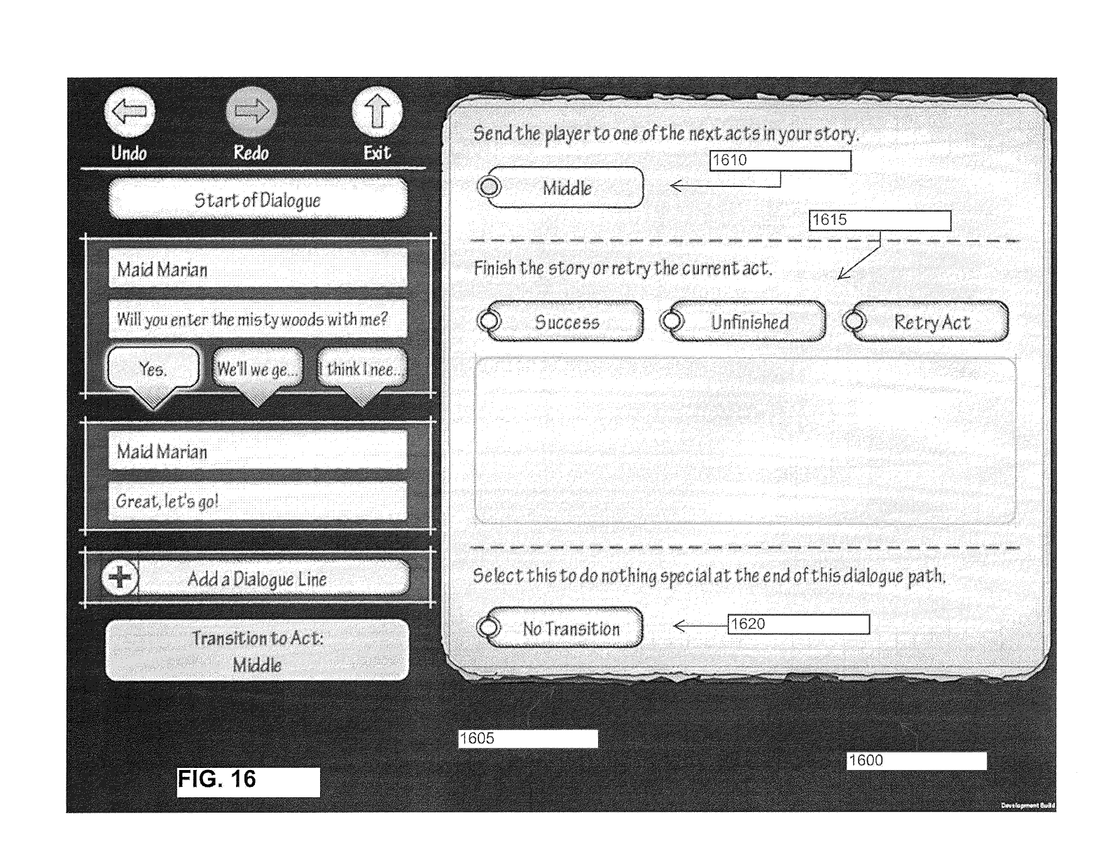

FIG. 16 illustrates an example user interface 1600 for the story development tool. User interface 1600 illustrates the transition editor 1605 that is displayed when the user selects transition button 1525. The transition editor 1605 allows the user to select an act to transition the interacting user to. For example, the user may select to transition the interacting user to the middle act as shown in the act selector 1610. The act selector may also display other acts that the user has added to the story. The transition editor 1605 allows the user to explain to the interacting user the type of transition. The transition explanation box 1615 allows the user to select whether the transition results in successful completion of the act, scene, or story, the act or scene remains unfinished, or the interacting user failed and should retry the act. The user may include text to provide additional details to the interacting user in the transition explanation box 1615. The text included may be displayed to the user during the transition. The user may also select transition option 1620 if at the end of the dialogue branch, no transition occurs.

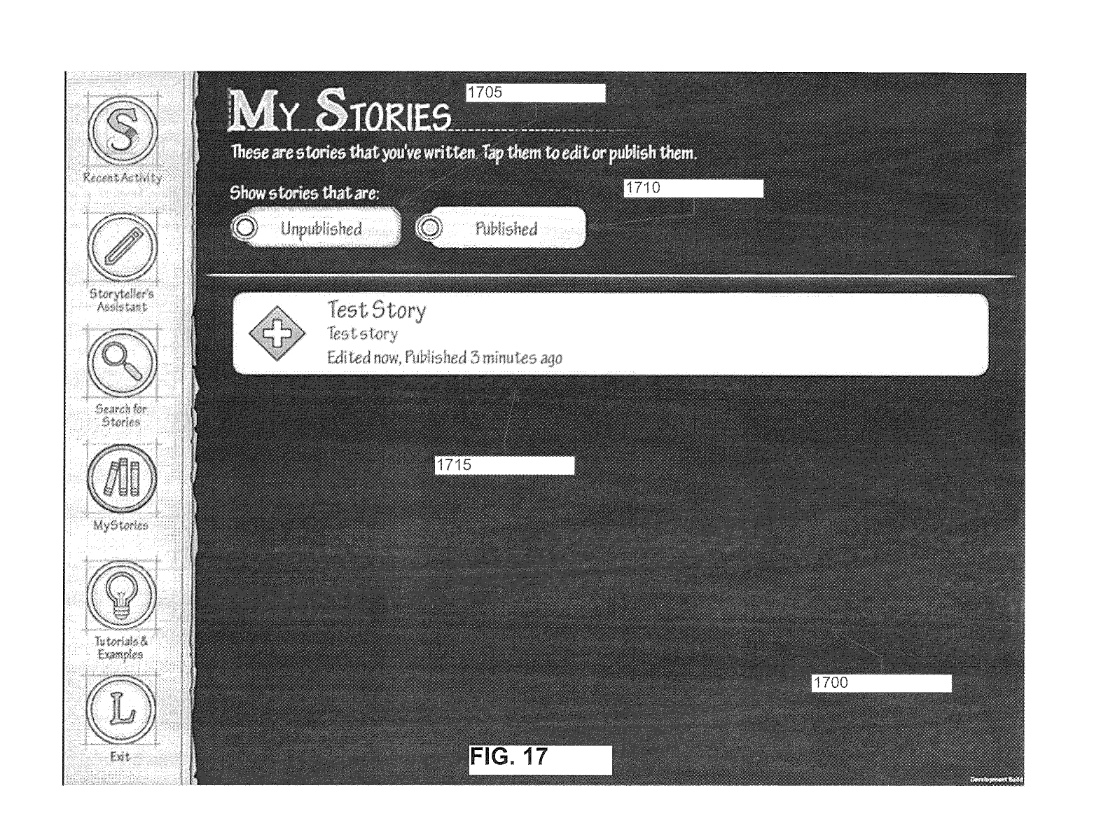

FIG. 17 illustrates an example user interface 1700 for the story development tool. User interface 1700 is shown upon the user selecting icon 230 and displays the stories that the user has published and that are still unpublished. The user may select radio button 1705 to display the stories that the user has not published. The unpublished stories may be uncompleted or complete stories that the user has not chosen to allow other users to interact with. The user may select radio button 1710 to display the published stories. The published or unpublished stories may be listed in the story feed 1715. For example, the user may select the radio button 1710 and then the published story TestStory will be listed. The story feed 1715 can include the title of the story and information relating to how recently the story was edited or published or both. Stories that are unpublished may be accessible offline and are editable by the user. Published stories are online and visible to other users. In some implementations, the user may select the other users who can access the published stories.

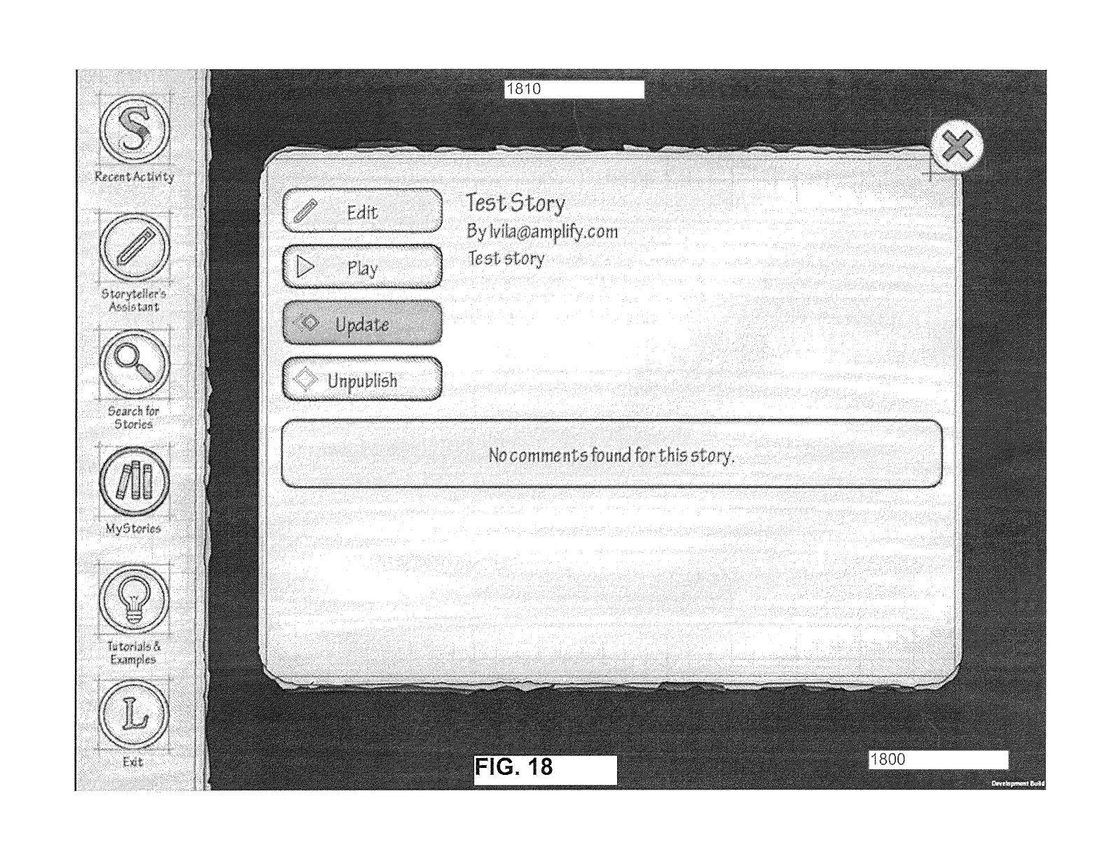

FIG. 18 illustrates an example user interface 1800 for the story development tool. User interface 1800 displays options that related to the stories shown in the story feed 1715. Selecting a story from the story feed 1715 displays a dialog box 1810. Dialog box 1810 allows the user to edit the selected story or play the selected story. The user may also change the story between published and unpublished. Dialog box 1810 may also display any comments that other users have left in the story.

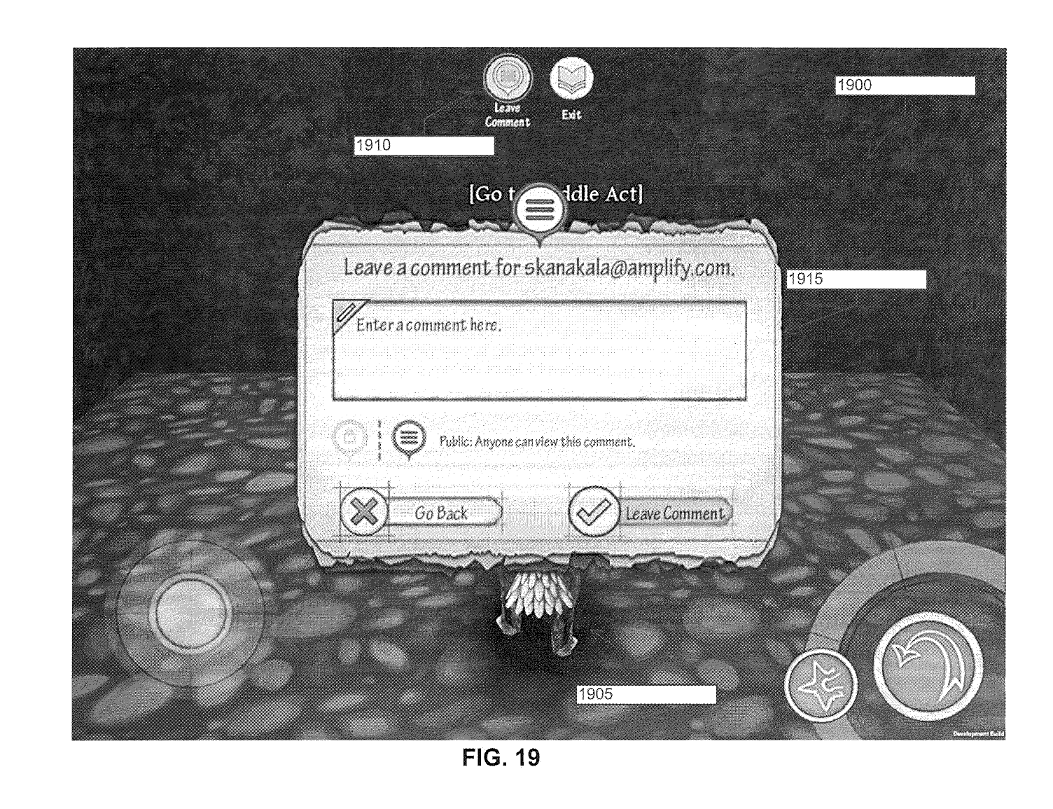

FIG. 19 illustrates an example user interface 1900 for interacting with the three dimensional world of a story. User interface 1900 illustrates a user interacting with the created story. The interacting user may be the user who created the story or another user. As the interacting user is moving the avatar 1905 around the setting, the user may leave a comment by selecting the comment button 1910. Upon selecting the comment button 1910, the comment dialog box 1915 is displayed. The comment dialog allows the interacting user to leave a comment for the user who created the story. The interacting user may choose for the comment to be public or private to the user who created the story. In some implementations, a moderator reviews and moderates the comments. In some implementations, an interacting user may leave a comment in published stories and not unpublished stories.

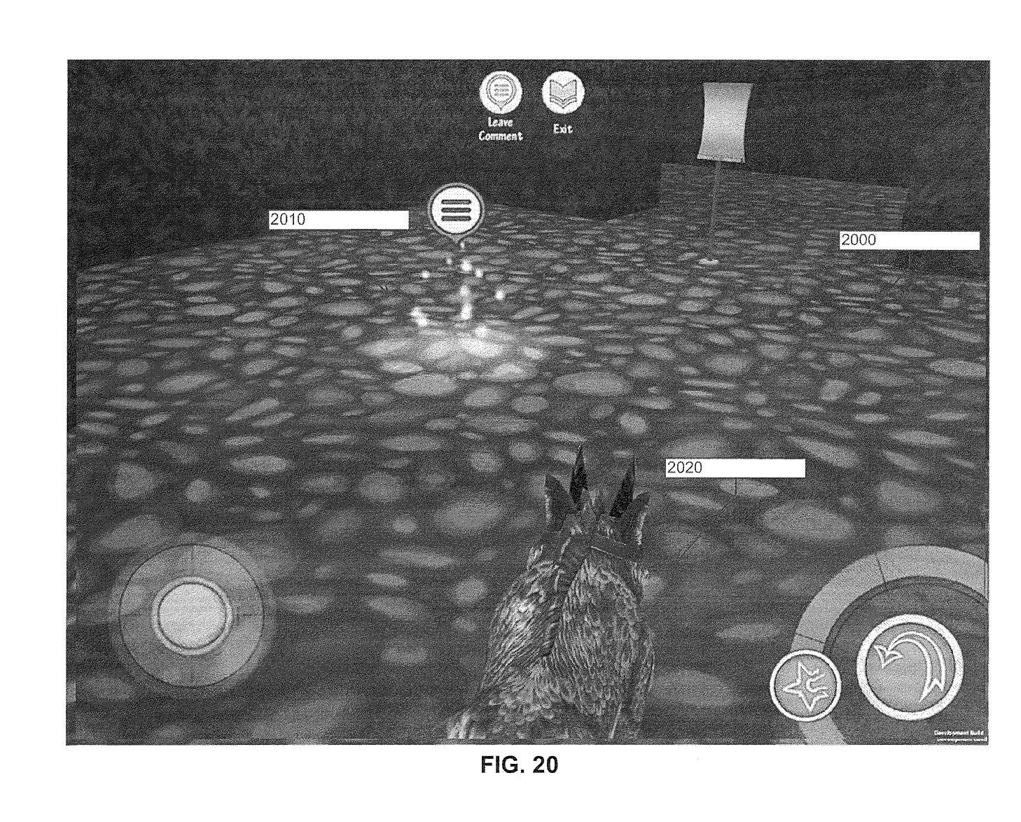

FIG. 20 illustrates an example user interface 2000 for interacting with the three dimensional world of a story. User interface 2000 illustrates a setting where an interacting user has left a comment. When a user leaves a comment the location is marked with marker 2010. The marker 2010 may be viewable to the users who have permission to see the comment. An interacting user may move the avatar 2020 to the marker 2010 to view the comment or may select the marker 2010 to view the comment.

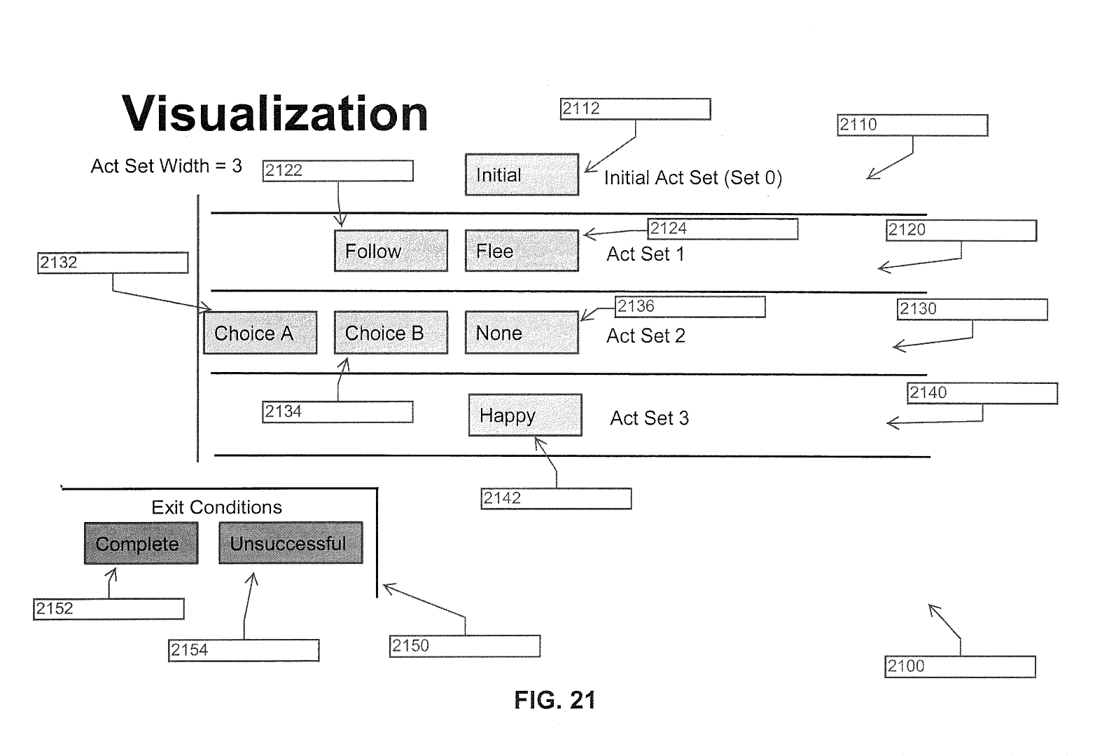

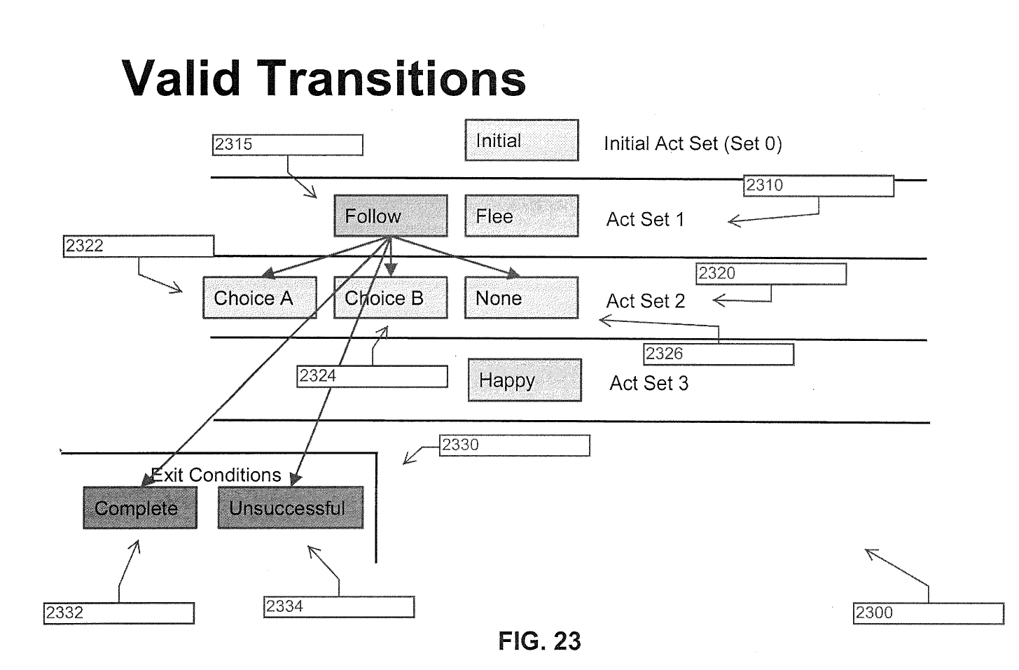

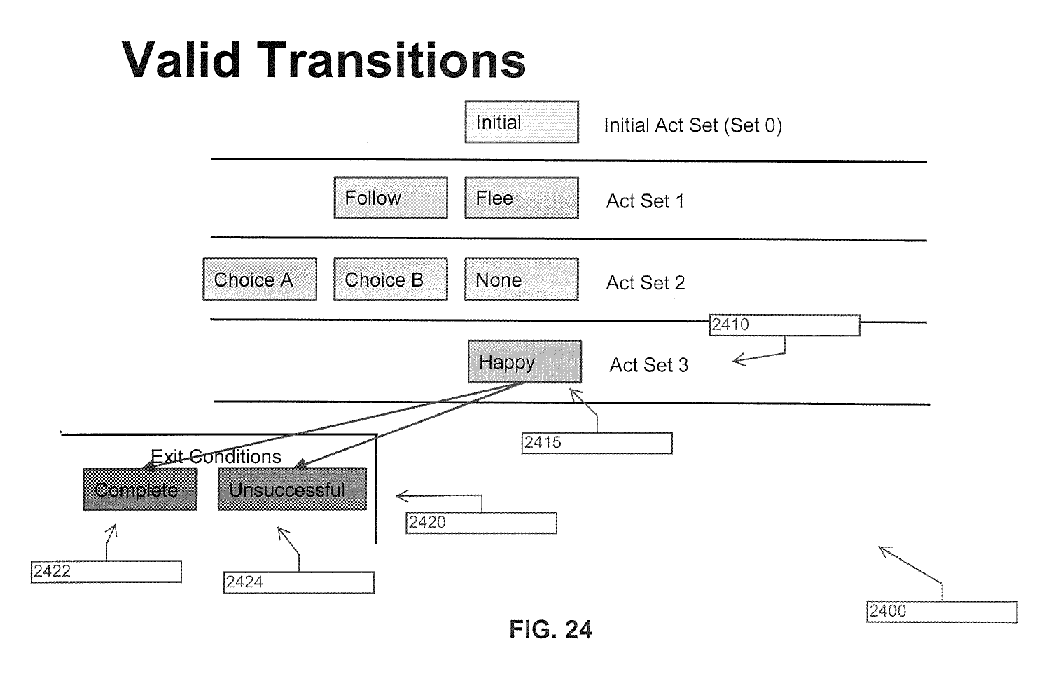

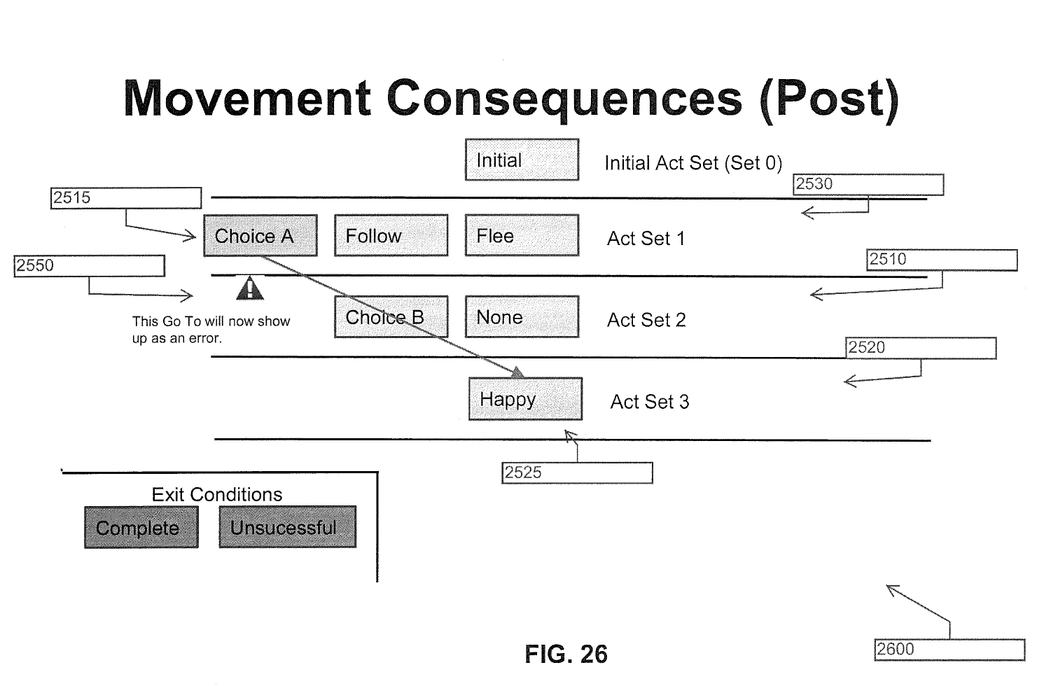

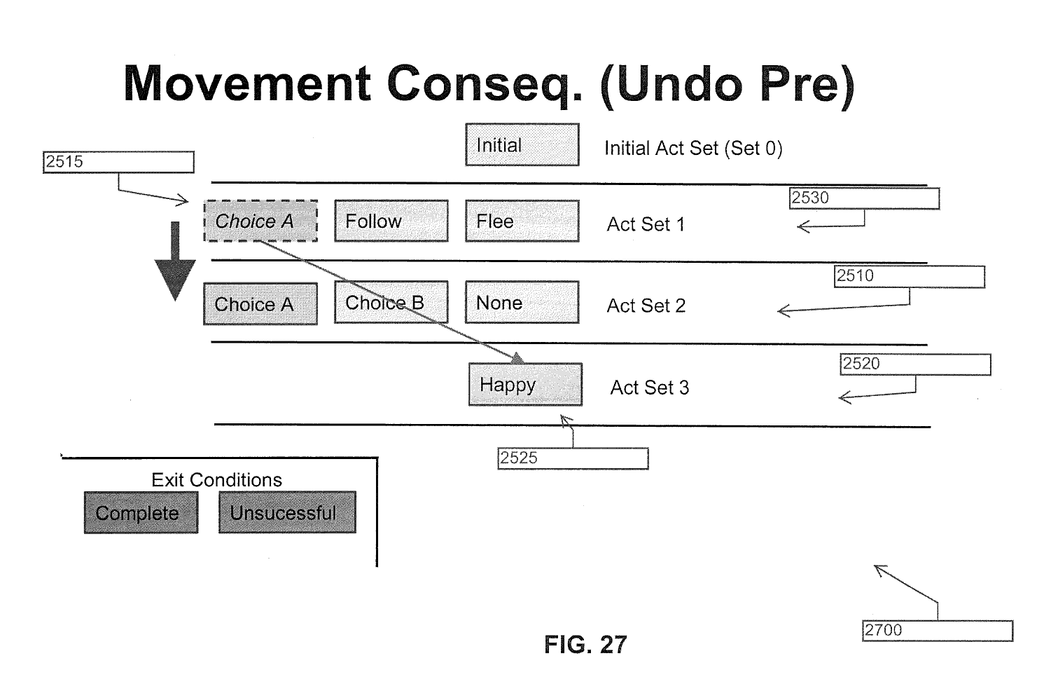

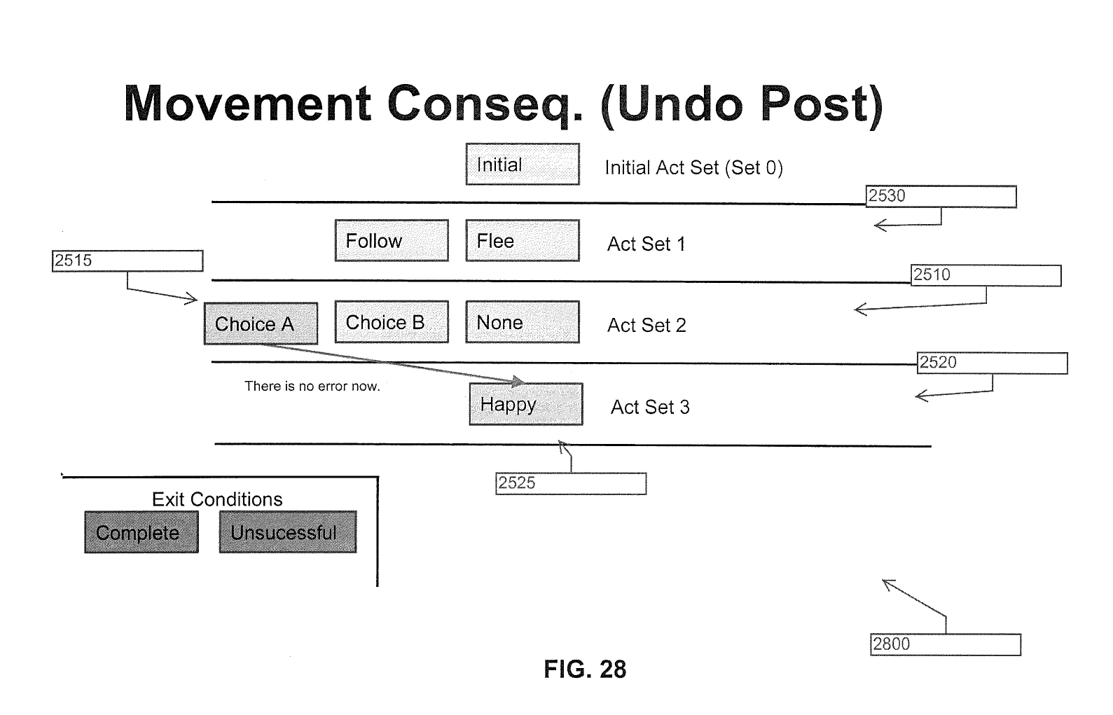

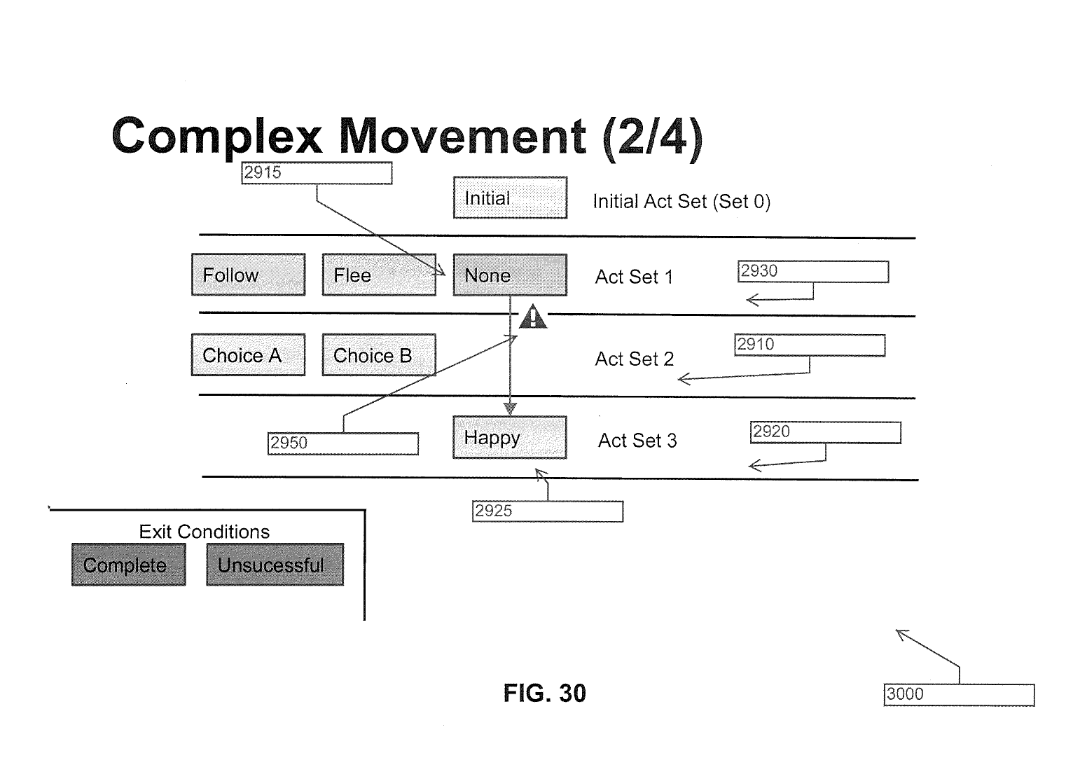

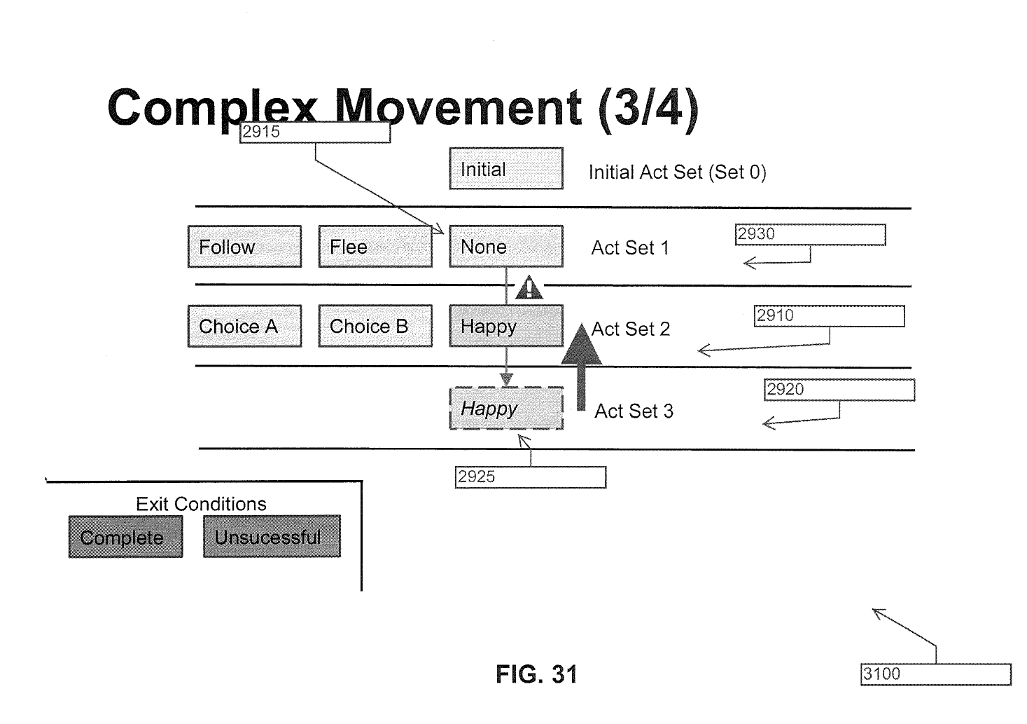

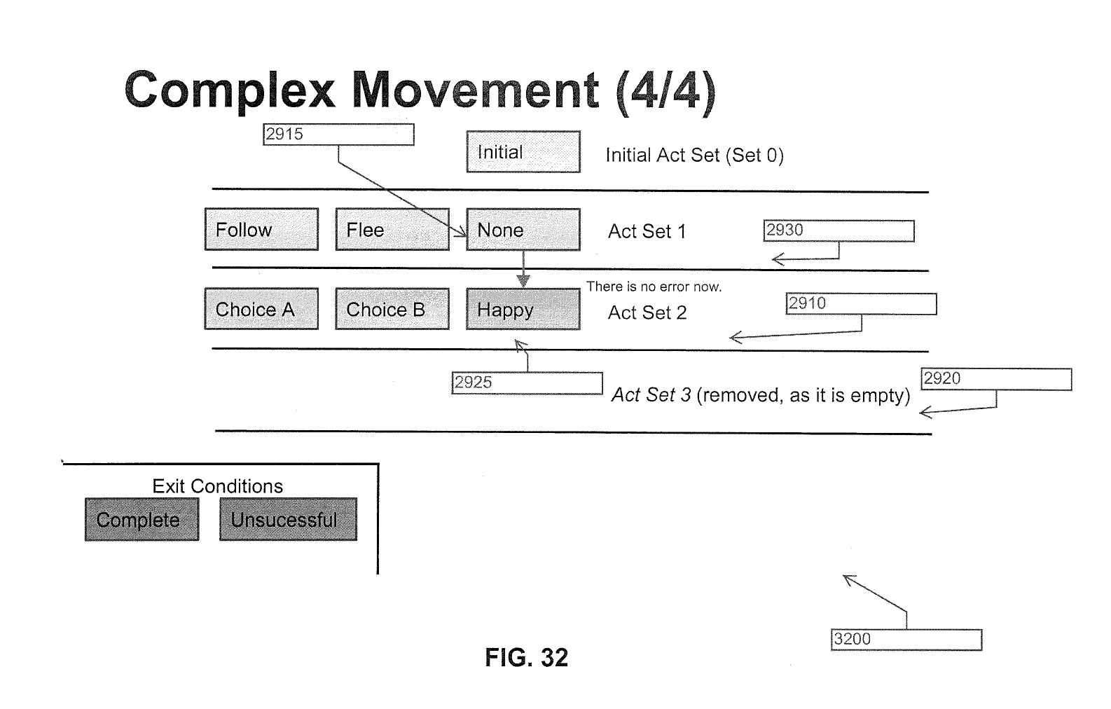

FIGS. 21-32 illustrate example schematics for a story structure. The schematics will be used to explain the various rules that the story development tool verifies as a user creates a story and the accompanying three dimensional world. Each schematic visually represents the different acts and options of a story that an interacting user or player may interact with. Each act may have different options that a user may create when developing the story. The options may be based on different dialogue sequences, movement by a player, or other player actions. Each option that transitions the player to another act is represented by a box and each arrow represents the transitions that a player can take to another act. If a user creates moves a character to a different act in the story, then the option associated with that character may move to a different act as will be shown in the schematics. In some implementations, the schematics are not provided as a user interface. In other implementations, a user interface based on the schematics may be provided. The user interface may display the option that may be causing an error in the story flow. The user interface may suggest a revision to correct the error or just identify the location of the error.

FIG. 21 illustrates an example schematic 2100 of a story structure. The schematic includes representations of the different scenes in different acts in an example story. In the example shown in schematic 2100, the user has created three acts for the story shown by act set 2120, act set 2130, and act set 2140. Each act has multiple options that may be accessed through various transitions that the user has included in the story. Act set 2120 includes a follow option 2122 and a flee option 2124. Act set 2130 includes a choice A option 2132, a choice B option, and a no choice option 2136. Act set 2140 includes a happy option 2142. The schematic 2100 also includes an act set 2110 with an initial option 2112. Each of the different options represents different transitions that the user has included in the story during creation. The transitions may be triggered by certain dialogue interactions or other actions by the user's avatar.

In some implementations, each story includes an act set with an initial option. The initial option may not be an act that the user created or an act that a user may interact with. Instead, the initial option may be a pointer to the first act created by the user, in this example, act set 2120. When creating the story, the user should ensure that the story flows from beginning to end. The user should ensure that a transition from a particular act advances the user to a subsequent act and does not return the user to a previous act. A user has finished the story once the user reaches one of the exit conditions 2150. If the user reaches the complete exit condition 2152, then the user has successfully finished the story. If the user reaches the unsuccessful exit condition 2154, then the user has not successfully finished the story.

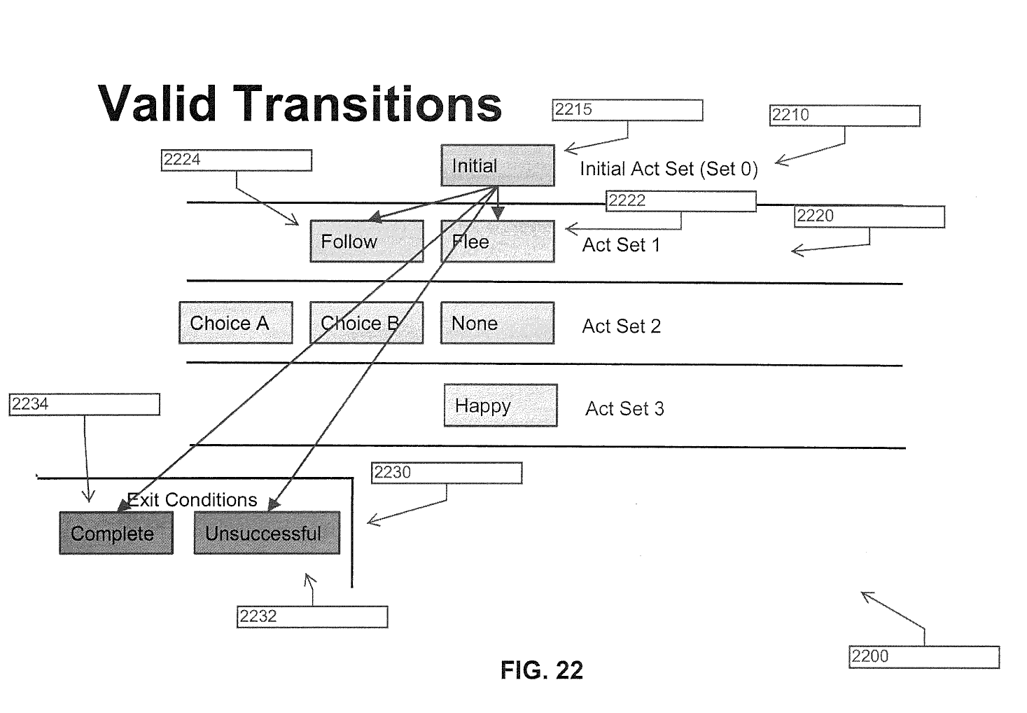

FIGS. 22-24 illustrates an example schematics 2200, 2300, and 2400 of a story structure. Schematics 2200, 2300, and 2400 illustrate different ways that an act may transition to a different act. As noted above, an act should not transition to a previous act. This rule is so that a user creating a story does not create a story where a user interacting with the story can move backwards in the story. In some implementations, a user can create a transition where the user interacting with the story can advance to an act that does not immediately follow the current act. As shown in schematic 2200, a user interacting with the initial option 2215 of the act set 2210 may transition to the follow option 2224 of act set 2220 or the flee option 2222 of act set 2220. Both of those transitions would be valid transitions because the user interacting with the story would be advancing to an act that immediately follows the current act. The user interacting with the initial option 2215 of act set 2210 may also transition to one of the exit conditions 2230 such as the complete exit condition 2234 or the unsuccessful exit condition 2232. Both of those transitions would be valid also because the user interacting with the story would be advancing to a subsequent act that does not immediately follow the current act.

Schematic 2300 illustrates other valid transitions. The transitions illustrated in schematic 2300 are valid because the interacting user may transition from the current to either a subsequent act that immediately follows the current act or to a subsequent act that does not immediately follow the current act. In schematic 2300, the user is currently interacting with the follow option 2315 of the act set 2310. Depending on the actions taken by the user, the user may transition to the choice A option 2322, the choice B option 2324, or the none option 2326, all of act set 2320. Alternatively, the user may transition to one of the exit conditions 2330 such as the complete exit condition 2332 or the unsuccessful exit condition 2334.

Schematic 2400 illustrates other valid transitions. The transitions illustrated in schematic 2400 are valid for the same reasons as the previous schematics. The user interacting with the story is currently in the happy option 2415 of act set 2410. Depending on the actions taken by the user, the user may transition to one of the exit conditions 2420 such as the complete exit condition 2422 or the unsuccessful exit condition 2424.

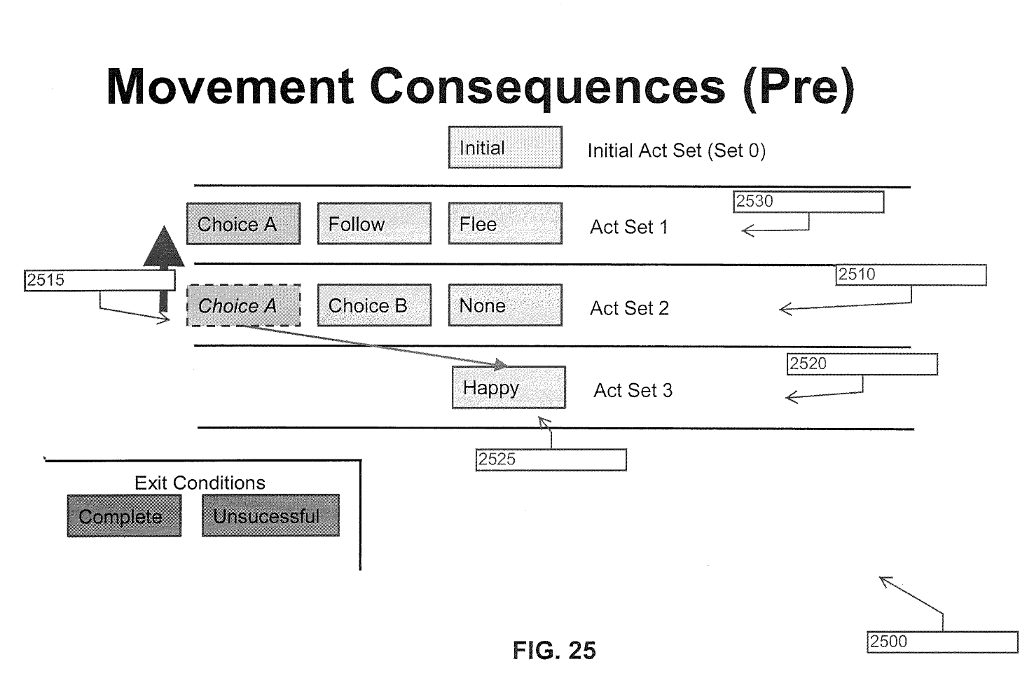

Additional errors may be possible in the act flow such as actions by a user creating the story that move an option to an inappropriate act. FIGS. 25-28 illustrate example schematics 2500, 2600, 2700, and 2800 of a story structure. Schematic 2500 illustrates a user who is creating the story and moving an option to a different act. Act set 2510 originally contains choice A option 2510 that transitions to the happy option 2525 of act set 2520. The user may edit the dialogue or actions that trigger the transition and may edit it so that choice A option 2510 is now in act set 2530. As the story development tool is periodically checking the flow of the acts, the story development tool determines that the choice A option 2510 being in act set 2530 causes an invalid transition. As illustrated in schematic 2600, choice A option 2515 is now in act set 2530 and error 2550 is now provided to the user creating the story. One way to fix the error is illustrated in schematic 2700. The user edits the dialog to action that triggers the transition to ensure that the trigger occurring happens in act set 2510 instead of act set 2530. As shown in schematic 2800, once the user makes the appropriate correction such as moving the choice A option 2515 back to act set 2510, the story development tool no longer produces an error.

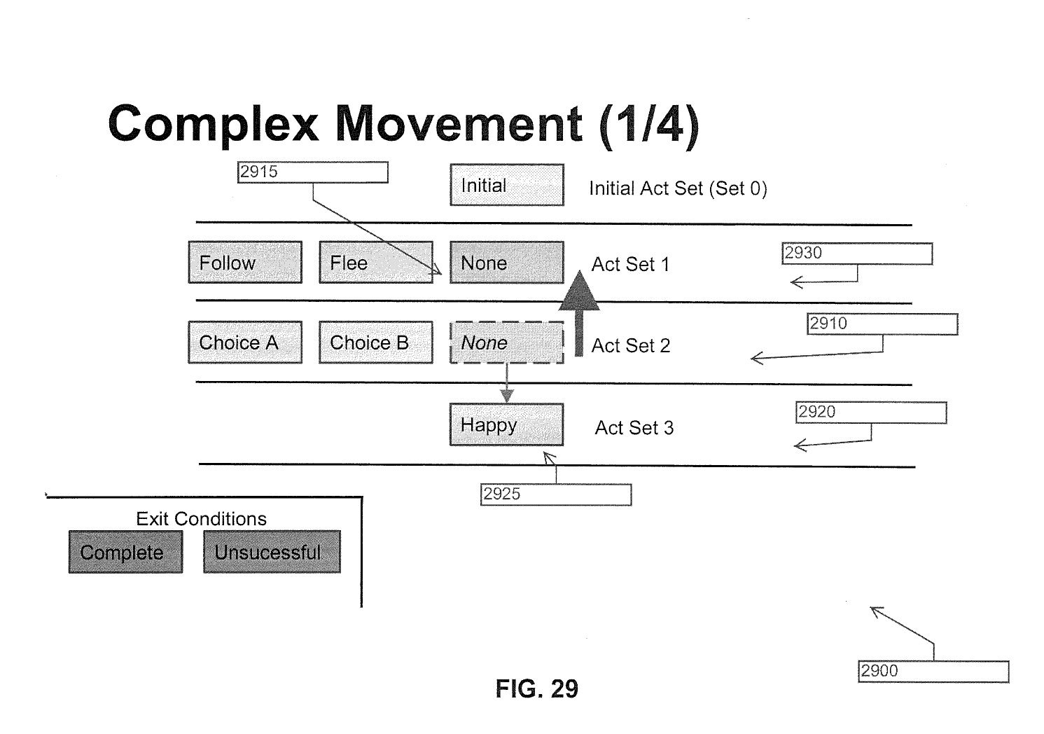

FIGS. 29-32 illustrate example schematics 2900, 3000, 3100, and 3200 of a story structure. Schematics 2900, 3000, 3100, and 3200 illustrate a similar error to schematics 2500, 2600, 2700, and 2800, but illustrate a different option to correct the error. Schematic 2900 illustrates the none option 2915 of act set 2910 transitioning to the happy option 2925 of act set 2920. The user edits the story to move the none option 2915 to act set 2930. Schematic 3000 illustrates that the none option 2915 is now in act set 2930 and still transitions to the happy option 2925 of act set 2920. Because this transition originally did not skip an act, the story development tool produces an error 2950.

To correct this error, schematic 3100 illustrates the user editing the story to move the happy option 2925 from act set 2920 to act set 2910. The result of the edit is illustrated in schematic 3200. In schematic 3200, the happy option 2925 is now in act set 2910 and the none option 2915 remains in act set 2930. While there is no option in act set 2920, that act is removed by the story development tool. Because the transition from the none option 2915 and the happy option 2925 originally did not skip an act, moving the happy option 2925 to act set 2910 removed the error caused by the transition skipping an act.

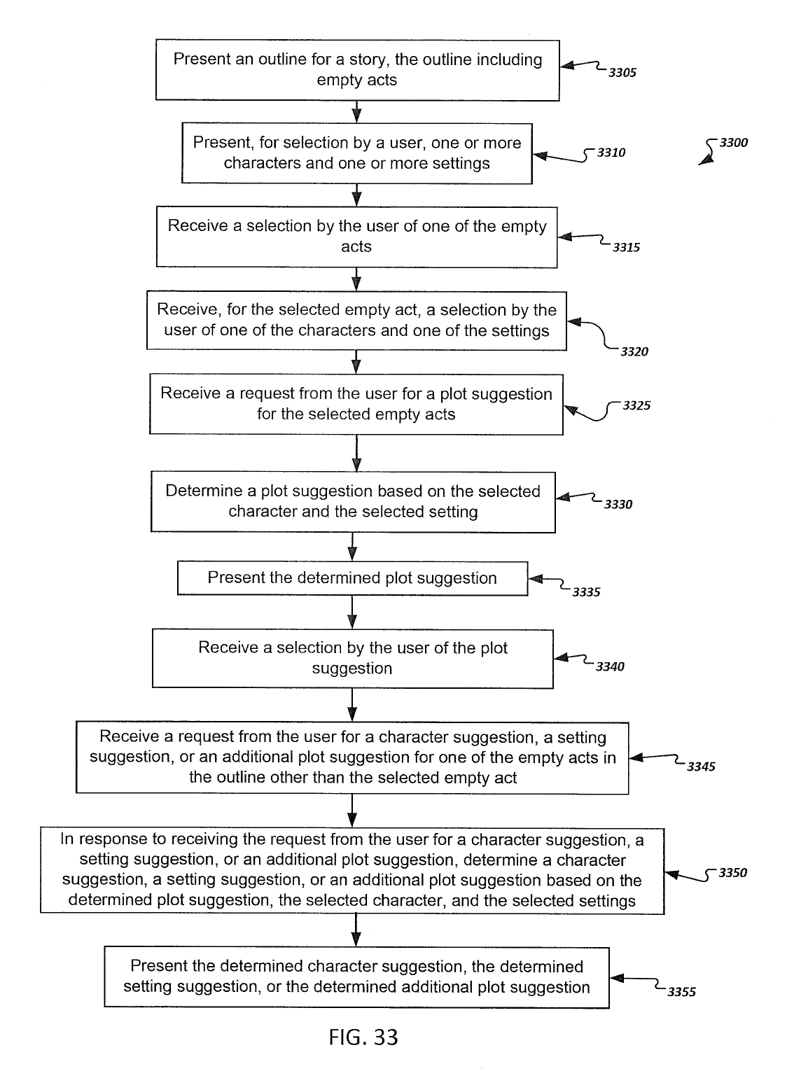

FIG. 33 is a diagram of an example process 3300 for a story development tool. The process 3300 may be performed by a computing device such as the computing device 105 from FIG. 1. The process 3300 provides a user with a story development tool to develop an interactive representation of a story. The process 3300 provides the user with suggestions for the plot, characters, or setting.

The device presents an outline for a story, the outline including empty acts (3305). In some implementations, the outline may include a beginning act and an ending act and one or more middle acts. The device presents, for selection by a user, one or more characters and one or more settings (3310). In some implementations, the device displays a list of characters that may include characters that the user has previously selected and additional random characters. In some implementations, the user creates a new character. Similarly, the device may display a list of settings that may include settings that the user has previously selected and additional random settings. In some implementations, the user creates a new setting.

The device receives a selection by the user of one of the empty acts (3315). The device receives, for the selected empty act, a selection by the user of one of the characters and one of the settings (3320). The device receives a request from the user for a plot suggestion for the selected empty acts (3325). The device determines a plot suggestion based on the selected character and the selected setting (3330). In some implementations, the plot suggestion is further based on previous stories created by the user or comments provided by other users on the previous stories created by the user.

The device presents the determined plot suggestion (3335). The device receives a selection by the user of the plot suggestion (3340). The device receives a request from the user for a character suggestion, a setting suggestion, or an additional plot suggestion for one of the empty acts in the outline other than the selected empty act (3345). The device in response to receiving the request from the user for a character suggestion, a setting suggestion, or an additional plot suggestion, determines a character suggestion, a setting suggestion, or an additional plot suggestion based on the determined plot suggestion, the selected character, and the selected settings (3350). In some implementations, the character suggestion may include a dialogue suggestion for the character or to respond to the character. In some implementations, the additional plot suggestion includes a transition suggestion that suggests that the user create a transition to an already created act, to an additional act, or to a scene in the current act. The setting suggestion may include a suggestion for a prop to include in the setting. The prop may be an interactive prop or non-interactive prop. An interactive prop may be a prop that player can interact with to transition to a different part of the story such as a different scene or act. The device presents the determined character suggestion, the determined setting suggestion, or the determined additional plot suggestion (3355).

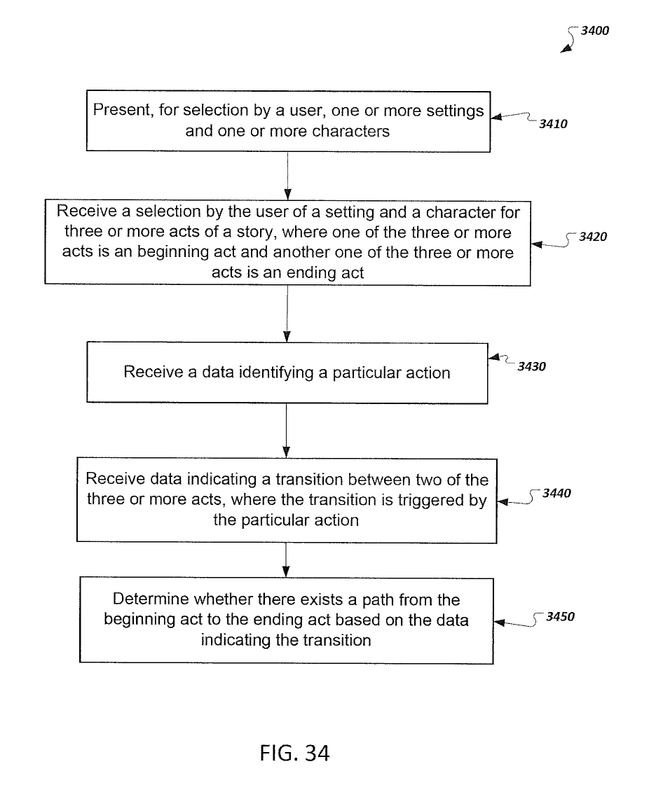

FIG. 34 is a diagram of an example process 3400 for a story development tool. The process 3400 may be performed by a computing device such as the computing device 105 from FIG. 1. The process 3400 provides a user with a story development tool to develop an interactive representation of a story. The process 3300 determines whether a player interacting with the story would be able to proceed in the story from the beginning to the end.

The device presents, for selection by a user, one or more settings and one or more characters (3410). The device receives a selection by the user of a setting and a character for three or more acts of a story, where one of the three or more acts is a beginning act and another one of the three or more acts is an ending act (3420). The user creates an interactive representations of a story for another user or player to experience. The user creates the settings, characters, and plot of the story. In some implementations, the device may require the user to create three acts in the story. Each act may have different scenes. The user creates a story that the player can interact with to start at the beginning act and reach the end act of the story. In some implementations, the story may have two or acts that includes a beginning act and an ending act.

The device receives data identifying a particular action (3430). The device receives data indicating a transition between two of the three or more acts, where the transition is triggered by the particular action (3440). In some implementations, the particular action is dialogue, an interaction with a prop, or a part of the setting. For example, to trigger a transition between the second act and the end act, the user may require an interacting player to initiate a conversation with a particular character and respond to a dialogue line with a specific line. As an example of a transition triggered by an interaction with a prop, the user may require the player to move the player's avatar to the prop to inspect the prop, move the prop to a different area of the setting or initiate dialogue based on the prop. As an example of a transition triggered by interacting with the setting, the user may require the player to move the player's avatar to a particular area of the setting or to initiate dialogue based on the particular area of the setting. A user may add any number of these transitions to the story.

The device determines whether there exists a path from the beginning act to the ending act based on the data indicating the transition (3450). In some implementations, the device may determine that there is a path from the beginning act to the ending act and indicate to the user that the path exists. In some implementations, the device may determine that a path from the beginning act to the ending act does not exist. The device may suggest an action to fix the error such as changing a transition for a particular dialogue interaction from one act to another act. The device may also not suggest an action to fix the error. Instead, the device may display a representation of the acts and an indication of the paths. The device may also just indicate to the user that there is an error and leave it to the user to find the error.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
presenting an outline for a story, the outline including empty acts;
presenting, for selection by a user, one or more characters and one or more settings;
receiving a selection by the user of one of the empty acts;
receiving, for the selected empty act, a selection by the user of one of the characters and one of the settings;
receiving a request from the user for a plot suggestion for the selected empty acts;
determining a plot suggestion based on the selected character and the selected setting;
presenting the determined plot suggestion;
receiving a selection by the user of the plot suggestion;
receiving a request from the user for a character suggestion, a setting suggestion, or an additional plot suggestion for one of the empty acts in the outline other than the selected empty act;
in response to receiving the request from the user for a character suggestion, a setting suggestion, or an additional plot suggestion, determining a character suggestion, a setting suggestion, or an additional plot suggestion based on the determined plot suggestion, the selected character, and the selected settings; and
presenting the determined character suggestion, the determined setting suggestion, or the determined additional plot suggestion.

2. The method of claim 1, wherein the empty acts include a beginning act, an ending act, and one or more middle acts.

3. The method of claim 1, wherein:
the one or more characters include previously selected characters and additional characters that are randomly selected, and
the one or more settings include previously selected settings and additional settings that are randomly selected.

4. The method of claim 1, wherein determining a plot suggestion based on the selected character and the selected setting comprises:
determining the plot suggestion further based on previous stories created by the user or comments provided by other users on the previous stories created by the user.

5. The method of claim 1, wherein the character suggestion includes a dialogue suggestion for the character or response suggestion to respond to dialogue from the character.

6. The method of claim 1, wherein the additional plot suggestion includes a transition suggestion to a created act that is in the outline, an uncreated act that is not included in the outline, or a scene in a current act.

7. The method of claim 1, wherein the setting suggestion includes a prop suggestion.

8. A computer-implemented method comprising:
presenting, for selection by a user, one or more settings and one or more characters;
receiving a selection by the user of a setting and a character for three or more acts of a story, wherein one of the three or more acts is a beginning act and another one of the three or more acts is an ending act;
receiving a data identifying a particular action;
receiving data indicating a transition between two of the three or more acts, wherein the transition is triggered by the particular action; and
determining whether there exists a path from the beginning act to the ending act based on the data indicating the transition.

9. The method of claim 8, wherein the particular action comprises dialogue, interaction with a prop, or interaction with a portion of the setting.

10. The method of claim 8, comprising:
receiving additional data indicating the transition is between one of the two of the three or more acts and a different act; and
determining whether there exists a path from the beginning act to the ending act based on the additional data indicating the transition.

11. The method of claim 8, wherein determining whether there exists a path from the beginning act to the ending act based on the data indicating the transition comprises:
determining that there exists the path from the beginning act to the ending act based on the data indicating the transition; and
presenting an indication that the path from the beginning act to the ending act exists.

12. The method of claim 8, wherein determining whether there exists a path from the beginning act to the ending act based on the data indicating the transition comprises:
determining that there does not exist the path from the beginning act to the ending act based on the data indicating the transition;
presenting an indication of different paths between the three or more acts; and
receiving data to revise the transition.

13. The method of claim 12, comprising:
presenting data indicating a correction to the transition so that the path from the beginning act to the ending act exists.

14. A system comprising:
one or more computers and one or more storage devices storing instructions that are operable, when executed by the one or more computers, to cause the one or more computers to perform operations comprising:
presenting an outline for a story, the outline including empty acts;
presenting, for selection by a user, one or more characters and one or more settings;
receiving a selection by the user of one of the empty acts;
receiving, for the selected empty act, a selection by the user of one of the characters and one of the settings;
receiving a request from the user for a plot suggestion for the selected empty acts;
determining a plot suggestion based on the selected character and the selected setting;
presenting the determined plot suggestion;
receiving a selection by the user of the plot suggestion;
receiving a request from the user for a character suggestion, a setting suggestion, or an additional plot suggestion for one of the empty acts in the outline other than the selected empty act;
in response to receiving the request from the user for a character suggestion, a setting suggestion, or an additional plot suggestion, determining a character suggestion, a setting suggestion, or an additional plot suggestion based on the determined plot suggestion, the selected character, and the selected settings; and
presenting the determined character suggestion, the determined setting suggestion, or the determined additional plot suggestion.

15. The system of claim 14, wherein the empty acts include a beginning act, an ending act, and one or more middle acts.

16. The system of claim 14, wherein:
the one or more characters include previously selected characters and additional characters that are randomly selected, and
the one or more settings include previously selected settings and additional settings that are randomly selected.

17. The system of claim 14, wherein determining a plot suggestion based on the selected character and the selected setting comprises:
determining the plot suggestion further based on previous stories created by the user or comments provided by other users on the previous stories created by the user.

18. A system comprising:
one or more computers and one or more storage devices storing instructions that are operable, when executed by the one or more computers, to cause the one or more computers to perform operations comprising:
presenting, for selection by a user, one or more settings and one or more characters;
receiving a selection by the user of a setting and a character for three or more acts of a story, wherein one of the three or more acts is a beginning act and another one of the three or more acts is an ending act;
receiving a data identifying a particular action;
receiving data indicating a transition between two of the three or more acts, wherein the transition is triggered by the particular action; and
determining whether there exists a path from the beginning act to the ending act based on the data indicating the transition.

19. A non-transitory computer-readable medium storing software comprising instructions executable by one or more computers which, upon such execution, cause the one or more computers to perform operations comprising:
presenting an outline for a story, the outline including empty acts;
presenting, for selection by a user, one or more characters and one or more settings;
receiving a selection by the user of one of the empty acts;
receiving, for the selected empty act, a selection by the user of one of the characters and one of the settings;
receiving a request from the user for a plot suggestion for the selected empty acts;
determining a plot suggestion based on the selected character and the selected setting;
presenting the determined plot suggestion;
receiving a selection by the user of the plot suggestion;
receiving a request from the user for a character suggestion, a setting suggestion, or an additional plot suggestion for one of the empty acts in the outline other than the selected empty act;
in response to receiving the request from the user for a character suggestion, a setting suggestion, or an additional plot suggestion, determining a character suggestion, a setting suggestion, or an additional plot suggestion based on the determined plot suggestion, the selected character, and the selected settings; and
presenting the determined character suggestion, the determined setting suggestion, or the determined additional plot suggestion.

20. A non-transitory computer-readable medium storing software comprising instructions executable by one or more computers which, upon such execution, cause the one or more computers to perform operations comprising:
presenting, for selection by a user, one or more settings and one or more characters;
receiving a selection by the user of a setting and a character for three or more acts of a story, wherein one of the three or more acts is a beginning act and another one of the three or more acts is an ending act;
receiving a data identifying a particular action;
receiving data indicating a transition between two of the three or more acts, wherein the transition is triggered by the particular action; and
determining whether there exists a path from the beginning act to the ending act based on the data indicating the transition.
